(19) United States
(12) Patent Application Publication
(10) Pub. No.: US 2021/0273598 A1
(43) Pub. Date: Sep. 2, 2021

(54) SOLAR MODULE RACKING SYSTEM

(71) Applicant: Skylite Solar Inc., Los Altos, CA (US)

(72) Inventors: Richard ERB, Los Altos, CA (US); Gilad ALMOGY, Los Altos, CA (US); Nathan BECKETT, Los Altos, CA (US)

(21) Appl. No.: 17/187,126

(22) Filed: Feb. 26, 2021

Related U.S. Application Data
(60) Provisional application No. 62/984,137, filed on Mar. 2, 2020.

(51) Int. Cl. H02S 20/23; H02S 30/10

(52) U.S. Cl. CPC H02S 20/23; H02S 30/10

(57) ABSTRACT

A solar module racking system comprises beams having a plurality of elongated solar modules spaced apart with intervening gap(s). The solar modules may be secured to the beams using a joint such as a key structure. Frames of the solar modules offer physical support to the racking assembly transverse to beam direction. Spacing the elongated solar modules in the racking system separated with intervening gaps, increases racking surface area overall. This results in a concomitant reduction in per-surface-area force necessary to secure the rack against wind and other forces. Racking system embodiments may be particularly suited to deploy solar panels upon large areas available in tilt-up roof configurations exhibiting reduced load-bearing capacity, that may be present in commercial buildings.

### CROSS-REFERENCE TO RELATED APPLICATION

The instant nonprovisional patent application claims priority to the U.S. Provisional patent application No. 62/984,137 filed Mar. 2, 2020 and incorporated by reference herein for all purposes.

### BACKGROUND

With the recognition of the harmful effects of global warming, the generation of usable power from solar energy is gaining increased acceptance. The large roof areas available to commercial buildings (e.g., warehouses, factories) offers an attractive location for the positioning of solar panels.

However, such commercial roof tops may be designed to primarily provide enclosure of the building interior from the outside environment (e.g., rain), rather than providing structural support. This property can reduce the load that such commercial roofs are able to support, including the weight of any solar power apparatus(es).

### SUMMARY

A solar module racking system comprises beams having a plurality of elongated solar modules that are spaced apart with intervening gap(s). The solar modules may be secured to the beams using a joint such as a key structure. Frames of the solar modules offer physical support to the racking assembly transverse to beam direction. Spacing the elongated solar modules in the racking system separated with intervening gaps, increases racking surface area overall. This results in a concomitant reduction in per-surface-area force necessary to secure the rack against wind and other forces. Racking system embodiments may be particularly suited to deploy solar panels upon large areas available in tilt-up roof configurations that exhibit reduced load-bearing capacity, as may be present in commercial buildings.

### BRIEF DESCRIPTION OF THE DRAWINGS

FIG. 1 is a simplified perspective view illustrating a solar module racking configuration according to an embodiment.

FIG. 1A is simplified view contrasting an embodiment with another module racking approach.

FIG. 1B is simplified view contrasting different embodiments of a module racking approach.

FIG. 2 is simplified flow diagram of a method according to an embodiment.

FIG. 3 is simplified perspective view illustrating an embodiment of a racking scheme.

FIG. 3A shows a simplified enlarged perspective view of the module racking embodiment of FIG. 3.

FIG. 3B shows another simplified enlarged perspective view of the module racking embodiment of FIG. 3.

FIG. 3C is simplified enlarged end view of the module racking embodiment of FIG. 3.

FIG. 3D shows another simplified enlarged perspective view of the module racking embodiment of FIG. 3.

FIG. 4A shows a simplified perspective view of a portion of a racking embodiment lacking a module.

FIG. 4B is simplified top view of an embodiment of a beam in a racking system.

FIG. 4C shows a perspective view of an alternative embodiment of a beam.

FIG. 5 shows a simplified perspective view of an embodiment of a joint in a racking system.

FIG. 5A shows a simplified side view of the embodiment of the joint shown in FIG. 5.

FIG. 5B shows a simplified side view of the embodiment of the joint shown in FIG. 5, positioned disposed within a beam member.

FIGS. 5C-5E show simplified perspective views illustrating the installation of the joint of FIG. 5 into a beam.

FIG. 6 is simplified perspective view of another embodiment of a joint.

FIGS. 7A-7B show simplified front and perspective views, respectively, of still another embodiment of a joint.

FIG. 8A shows a simplified perspective view of another embodiment of a joint disposed on a beam.

FIG. 8B shows a simplified perspective view of the installation of a module into the embodiment of the joint depicted in FIG. 8A.

FIG. 9A shows a simplified perspective view of one embodiment of a module frame, with a module in place.

FIG. 9B shows a simplified end of the module frame of FIG. 9A.

FIG. 9C illustrates an enlarged perspective view of a module frame and module according to an embodiment.

FIG. 9D illustrates a simplified perspective view of a module frame embodiment.

FIGS. 9E and 9F illustrate end views of module frame embodiments.

FIGS. 10A-B are simplified perspective views illustrating installation of a module frame into a joint according to an embodiment.

FIG. 11 is a simplified perspective view illustrating mating between a joint and an installed module frame, according to one embodiment of a racking system.

FIG. 12 shows a simplified perspective view of a beam-to-beam connection according to an embodiment.

FIG. 12A shows a simplified perspective view of a beam-to-beam connection according to an alternative embodiment.

FIGS. 13A-B show perspective views of different key structure designs being secured by welding to a beam.

FIG. 13C shows a simplified perspective view of an embodiment of a clip.

FIG. 13D shows a simplified view of the clip embodiment of FIG. 13C attaching to a module frame.

FIG. 13E shows a detail view of attachment of a metal beam using the clip embodiment of FIG. 13C and clinch joint.

FIG. 13F shows a perspective view illustrating another embodiment of a joint.

FIGS. 14A-B show perspective and enlarged views respectively, of an embodiment featuring a walkway being located in a gap.

FIG. 15 shows a perspective view of key structures in a back-to-back orientation.

FIGS. 16A-C are end views of the key structure showing the heel-to-toe forces.

FIG. 17 is a top view further showing the role of the key structure.

FIG. 18A shows a perspective view of a solar module racking approach according to an alternative embodiment, during installation.

FIG. 18B shows a detail view of the solar module rack of FIG. 18A.

FIG. 18C shows a detail view of the solar module rack of FIG. 18C during installation.

FIG. 18D shows a perspective view of a beam according to the embodiment of FIG. 18A.

FIG. 18E is an end view of a beam showing installation of a cross-member.

FIG. 18F is an end view of a beam showing installation of a wedge member.

FIG. 19A is a simplified perspective view showing an array of staggered base plates according to an exemplary embodiment.

FIG. 19B shows the array of staggered base plates of FIG. 19A, having solar modules affixed thereto.

FIG. 19C shows an enlarged perspective view of the array of staggered base plates of FIG. 19A.

FIG. 19D shows an enlarged perspective view of one side of inter-digitated base plates.

FIG. 19E is a simplified cross-sectional view of one tabbed side of a base plate.

FIG. 19F shows a further enlarged perspective view of one side of inter-digitated base plates.

FIG. 19G shows a cross-section of a base plate supporting a module, and adjacent base plates and modules.

FIG. 19H shows an enlarged view of the cross-section of FIG. 19G.

FIG. 20 shows a partial perspective view of an embodiment of a base plate having one cross member and comprising a single piece.

FIG. 21 shows a partial perspective view of another embodiment of a base plate having one cross member and comprising multiple pieces.

FIG. 22 shows a perspective view of an array of base plates according to an embodiment held down by ballast bricks.

FIG. 23 shows a perspective view of an array of base plates and modules according to an alternative embodiment including a pathway for access and/or cable routing.

FIG. 24 shows a perspective view of an embodiment of a module array including a cleaning robot.

### DESCRIPTION

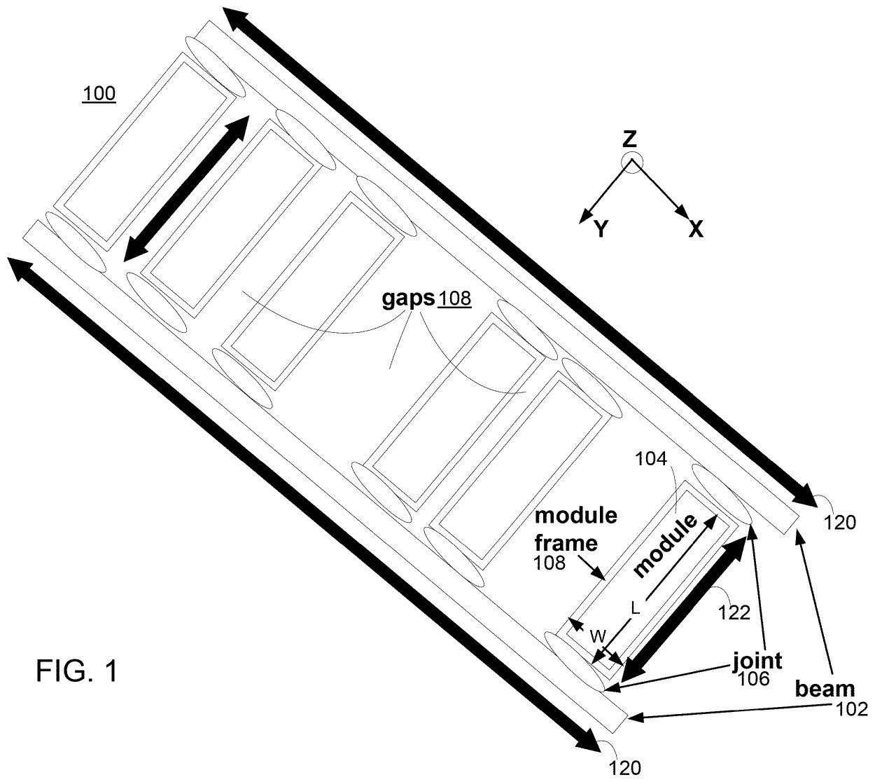

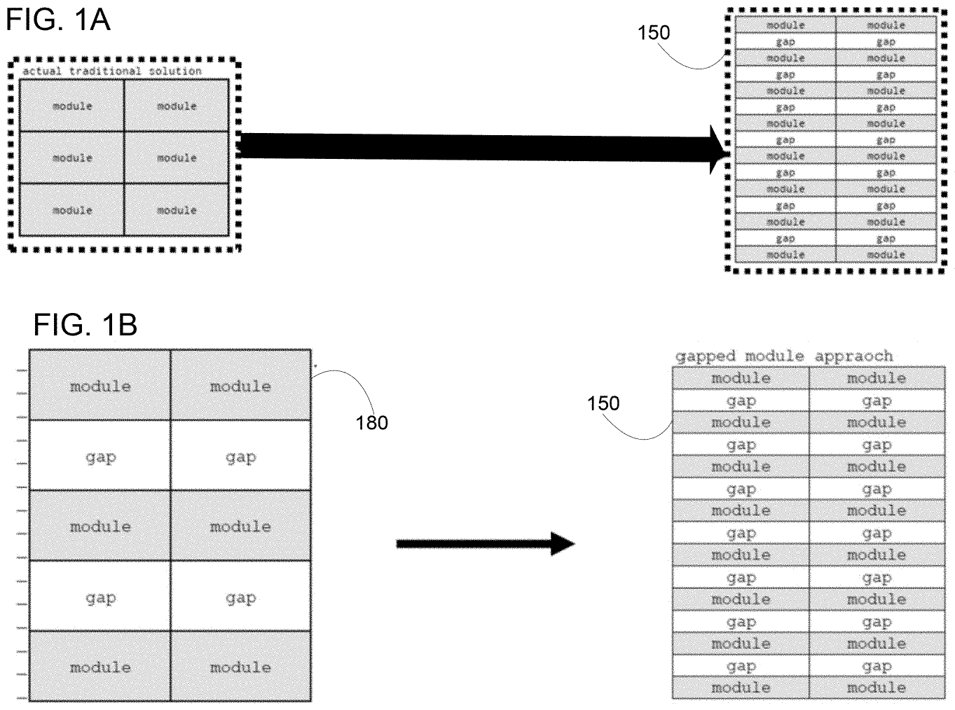

FIG. 1 is a simplified perspective view illustrating a solar module racking configuration according to an embodiment. In particular, the solar module rack embodiment 100 comprises a pair of beams 102.

These beams are stiff and lack flexibility in the Z direction. Accordingly, the beams are configured to transmit force 120 along that axis. The force is resolved as a bending force in the beam. Examples of bending moments that can be transmitted range from 400-4000 ft-lbs.

Here, the beams are oriented parallel to one another. However, this is not strictly required in all embodiments, and in some embodiments the beams could be other than parallel.

Solar modules 104 are physically connected to beams 102 via intervening joints 106. Details regarding various possible embodiments of joints, are described later below. At a minimum, however, the joints are designed to retain the solar panel in place (in all directions) to the beam, and to transmit a bending force from adjacent solar panels in the Y direction.

The solar modules are characterized by a length dimension L (along the Y-axis), and a width dimension W (along the X-axis). Depending upon the particular racking system embodiment, the L:W aspect ratio can vary, for example width can be from about 6″ to 36″ and L could be from about 12″ to 96″.

The module may include a frame 108. That frame may be designed to exhibit different strengths in the W and L dimensions. Specifically, the frame may exhibit a greater strength in the L dimension (along the Y-axis, perpendicular to the beams).

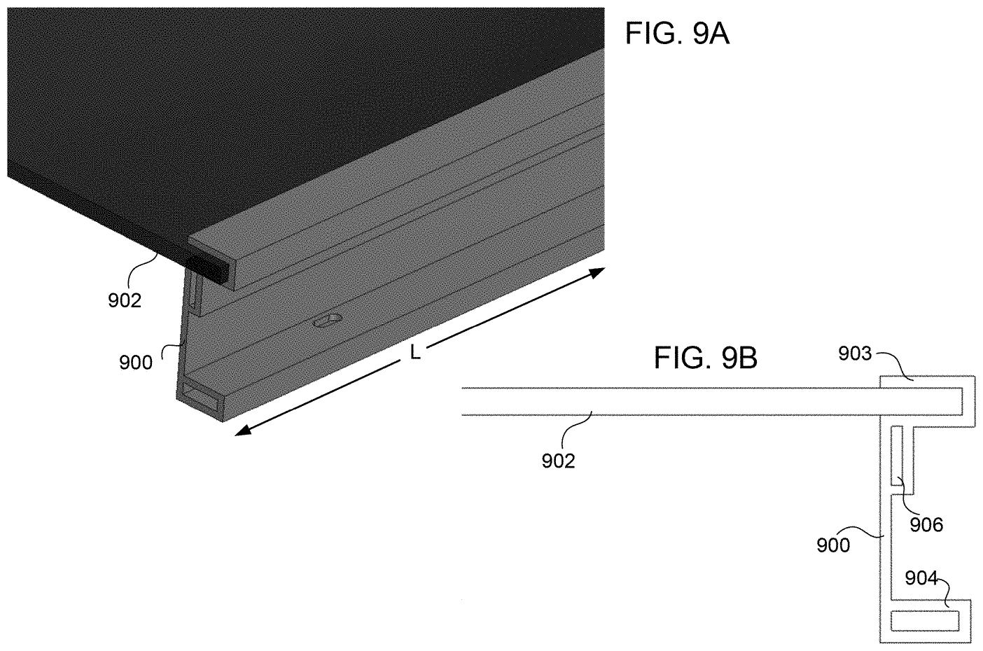

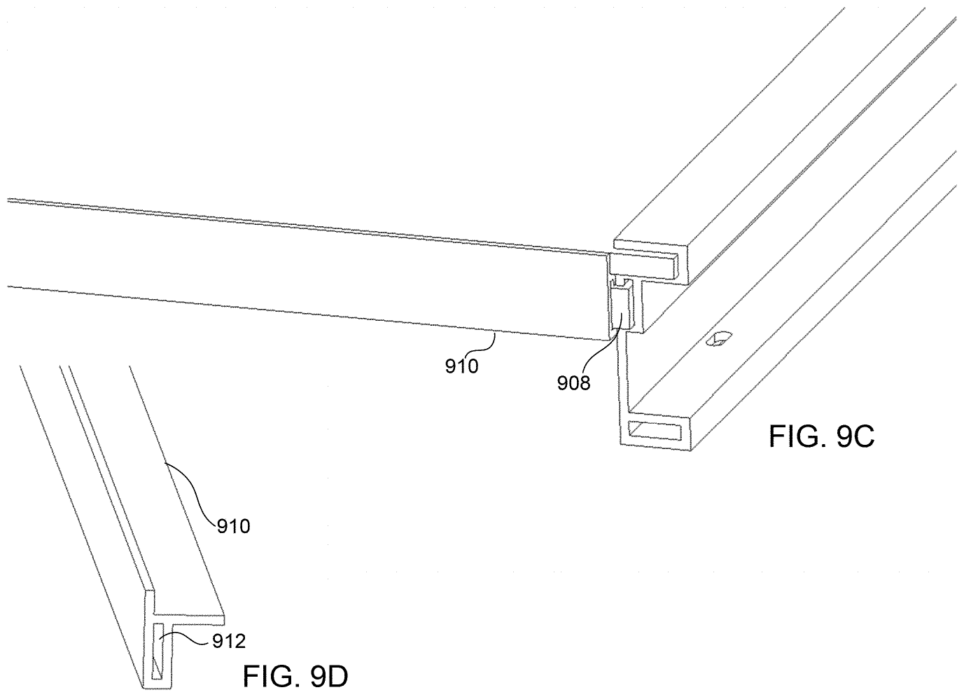

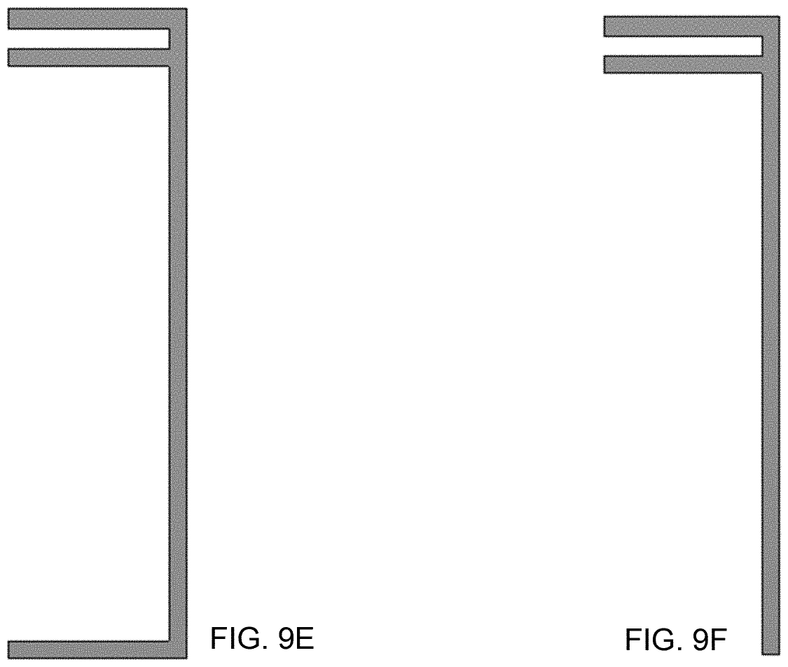

In this manner, the racking system may be designed rely (in part) upon the structural strength of the module itself (i.e., the module frame), in order to provide sufficient rigidity to resist external forces (e.g., wind), and transmit forces 122 (e.g., along the Y-axis). Details regarding various module frame embodiments are provided later below at least in connection with FIGS. 9A-9G.

Along the beams, the joints may space apart the solar modules from each other by gaps 108. As shown in the particular embodiment of FIG. 1, the gaps are not necessarily of equal dimensions.

However, in some embodiments the dimensions of the gaps may be repeated, and the gaps regularly spaced. In particular embodiments, the gap dimensions could correspond to those of a solar module, thereby resulting in even spacing. Such an embodiment of a racking system is shown as 150 in the FIGS. 1A and 1B discussed below.

As discussed below, the gaps are deliberately introduced with careful attention to their dimensions. The gaps serve to increase the overall area of the racking system, reducing (or even eliminating entirely) the need for a separate ballast weight to be provided to resist forces (such as wind) and maintain the racking system in contact with the roof

Racking systems according to embodiments may be characterized in terms of the area occupied by gaps, as compared to the module area. This property (e.g., a porosity) could vary from between about 5% to about 75%.

FIG. 1A is simplified view contrasting an embodiment with a conventional solar module racking approach. In particular, the comparison of FIG. 1A shows that an embodiment 150 of the racking system holds itself down on the roof by being self-ballasted with its own weight over a large area.

The larger total connected area of the racking system embodiment allows separate ballast to be light, or even non-existent. The gaps intentionally integrated between the solar panels permit structural continuity to be maintained, while the racking system embodiment is lighter and yet can withstand the same wind speeds.

As described above, the racking system embodiment 150 works in both planar dimensions (e.g., X and Y in FIG. 1). This is achieved with the strength of the beams, module frames, and joints.

Even though the two approaches that are compared in FIG. 1A offer the same amount of solar area (that would catch the same net cross sectional area of wind), the embodiment 150 exhibits a lower peak total wind pressure because it is catching wind over a larger total area that includes the deliberately introduced gaps.

FIG. 1B is simplified view contrasting a couple of different embodiments 150 and 180 of various racking approaches. In particular, it is noted that the embodiment 150 may exhibit greater structural efficiency than the embodiment 180, due to the high aspect ratio of the solar panels that are supported.

In particular, the smaller modules of the embodiment 150 provide a more efficient layout of this gapping scheme due to the smaller pieces offering better packaging densities. In addition the use of small and more frequent modules and gaps results in a smoother and more uniform distribution of forces caused by wind uplift.

It is noted that deploying smaller modules in general provides a lower total force per module, albeit with a higher quantity of connections. So, the installation of such attachments can be done more easily without tools.

It is noted that long unsupported structural sections in the gap will have higher moments. As bending depends upon length², a more evenly loaded structure is preferable

Based upon such considerations, examples of gap widths can range from about zero to between about 3× a module width (e.g., around 39″). Along the L direction, no gaps may be present, or gaps could be on the order of about 6″ or less.

Particular embodiments may feature distances of from about 2″ to about 39″. Or, expressed in terms of a module width (W), the gap may be between about W/6 to 3×W.

It is noted that the existence of gaps may provide locations for the inclusion of integrated walkways. Typically, fire code requires that skylights and other roof features be accessible via walkway. This can impose limits upon how a solar array is laid out.

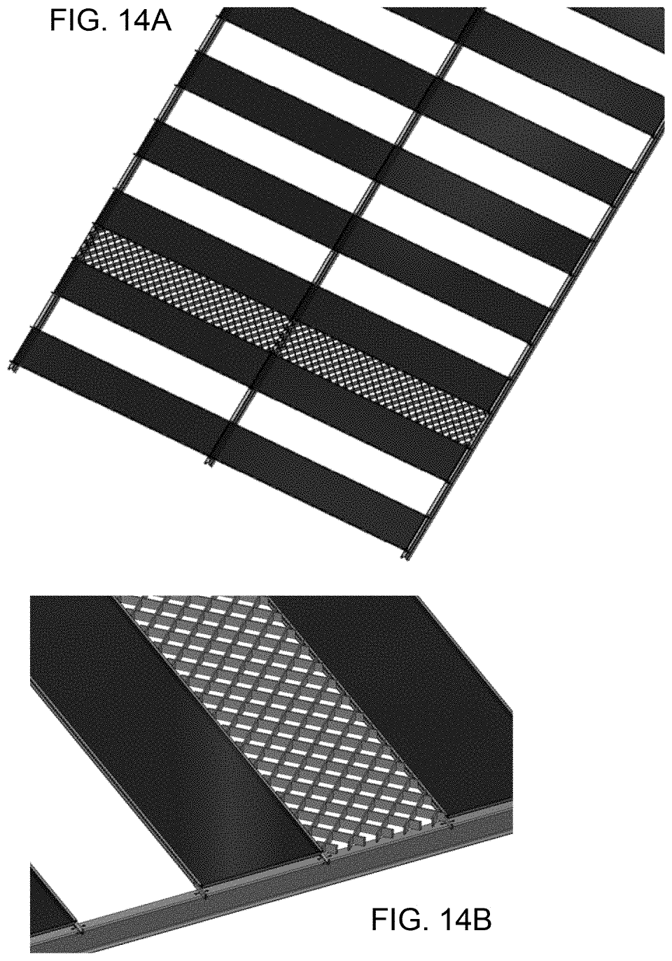

However, due to the natural spacing offered by embodiments, steel grating (or other types of walkway) could be added in the gaps between modules. FIGS. 14A-B show perspective and enlarged views respectively, of an embodiment featuring a walkway being located in a gap.

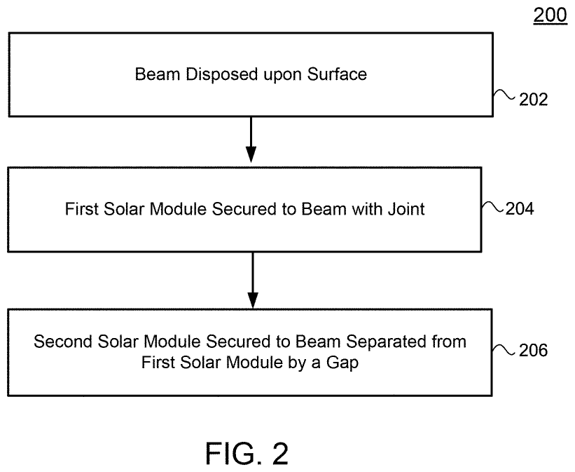

FIG. 2 is simplified flow diagram of a method 200 according to an embodiment. In particular, at 202 a first beam is disposed extending in a first direction on a surface.

At 204, a first solar module is secured to the beam with a first joint. The first solar module has a width dimension in the first direction and a length dimension in a second direction, the length dimension larger than the width dimension.

At 206, a second solar module is secured to the beam with a second joint. The second solar module is separated from the first solar module by a gap.

Solar module racking systems according to embodiments may offer one or more benefits as compared with conventional approaches. For example, embodiments may provide greater flexibility in layout options.

Specifically, various buildings offer different roof capacity, and a different combination of wind, snow, and earthquake requirements. Using a conventional, non-gapped approach, conventional solar module racking systems may be over-designed, surrendering excess margin (money) for particular building project specifications and/or wind zones that are not necessarily present at the edge of the design space.

Traditional racking approaches may manifest such over-design by utilizing an excess amount of ballast underlying a panel. However, there is a limit of maximum ballast that a roof can support. This is particularly true for tilt-up roof designs that are prevalent for the large roofs of commercial buildings located in mild climates where snow/ice accumulation is not a concern (i.e., precipitation is in the form of liquid rain that drains off and does not accumulate, obviating the need to be supported by the strength of the roof).

By contrast, embodiments offer the flexibility to change gap spacing to accommodate different wind regions. Thus for low wind regions, gap spacing may be reduced to pack modules more tightly together, and result in a higher power density per roof surface area. Alternatively, for high wind regions, racking embodiments may space modules further apart, resulting in lower power density but also exhibiting lower wind loads per-unit-surface-area.

Such an adjustment to accommodate different expected wind loads can be accomplished without introducing new parts. Rather, joints may be positioned with different spacings along the beam—e.g., by drilling holes per the specific example below—a low cost modification.

### EXAMPLE

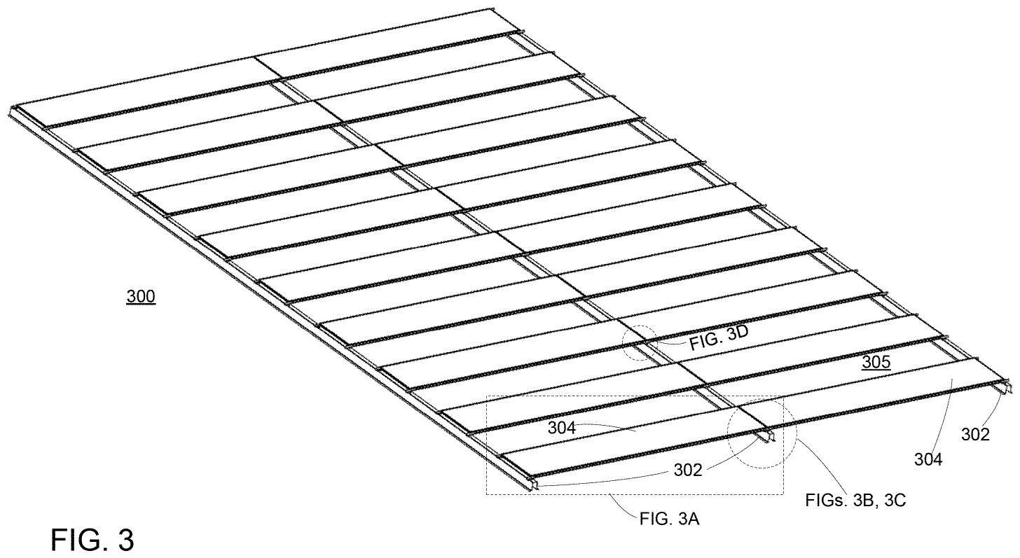

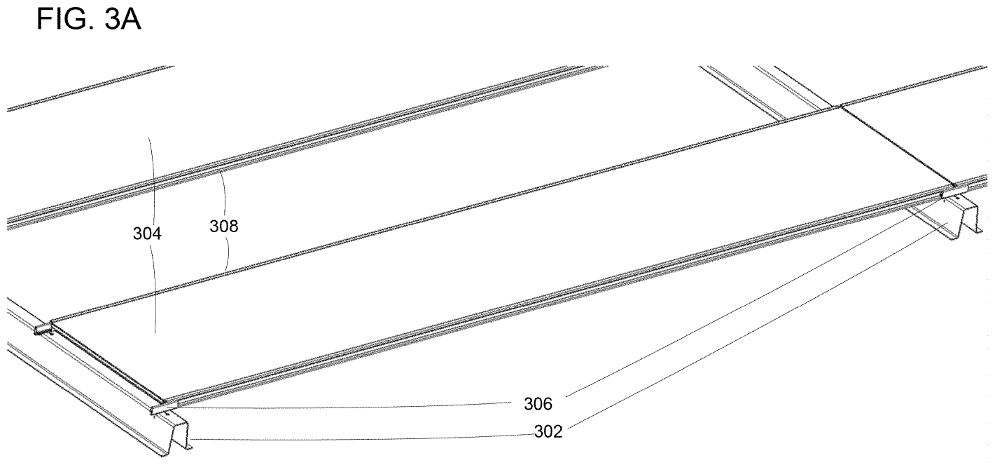

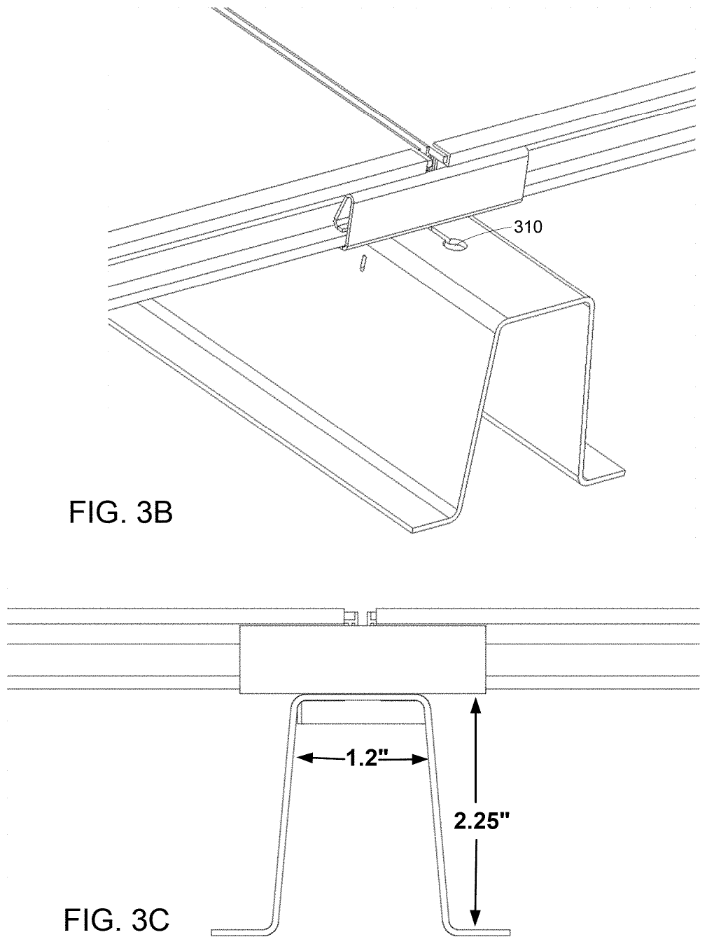

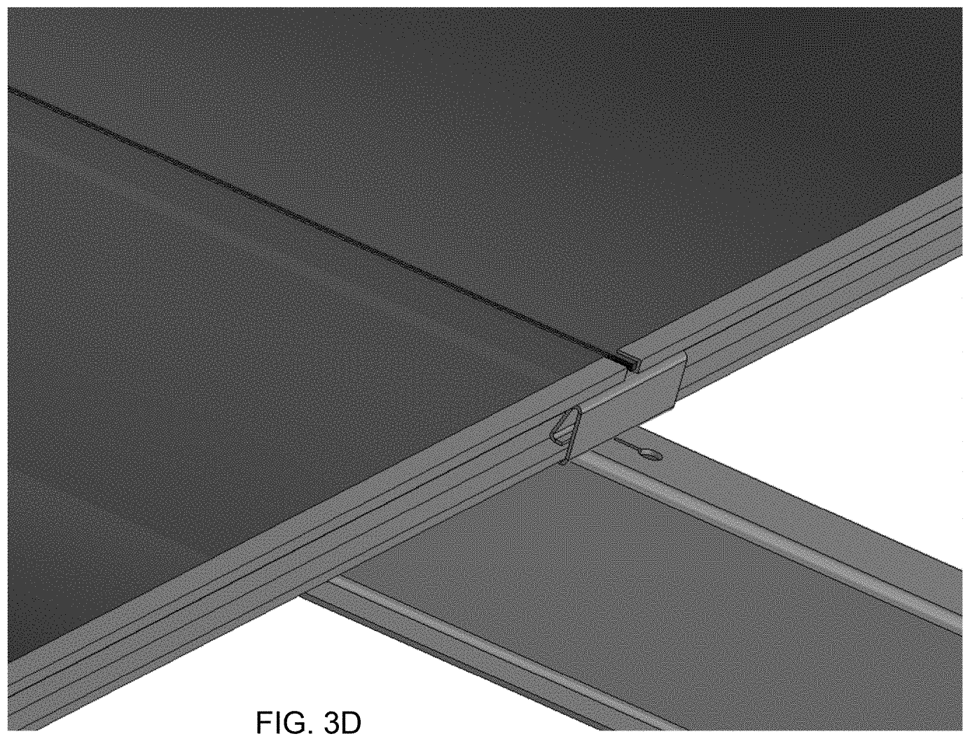

FIG. 3 shows a simplified perspective view illustrating a solar module racking scheme according to one embodiment 300. As in the previous embodiment 150, this specific embodiment features a trio of parallel beams 302 supporting two rows of solar modules 304, with gaps 305 deliberately introduced between them.

FIG. 3A shows a simplified enlarged perspective view of the module racking embodiment of FIG. 3. FIG. 3A shows the joint 306 present between the beam and the module.

In the embodiment according to this example, the module width is about ⅓rd of a conventional module width (i.e., in the short direction). Thus, if a conventional solar module has a width along a short side of ˜3 ft, then the instant embodiment of a solar module has a width of about 1 ft.

Such a module embodiment may offer ⅓rd of the power of a conventional module, that would be deployed by continuously racking twenty-four conventional 6″ solar cells. Further details regarding various possible module designs, are provided later below.

It is noted that racking systems according to embodiments can operate effectively with a module having almost any aspect ratio. However, a smaller W:L ratio may be more desirable. Module aspect ratio may be tailored for spacing based upon wind resistance considerations.

This particular example has a stronger frame 308 in the direction perpendicular to the beam. More material per watt may be used to structurally connect the system to allow for reduced (or even zero) ballast. A lighter strength frame (or even no frame at all) may be present in the direction along the beam. This is because that dimension of the module is not called upon to carry a significant load. Rather, significant loads in the direction of the module short side, are shouldered by the beam.

FIG. 3B shows another simplified enlarged perspective view of the module racking embodiment of FIG. 3. As show, here the joint is in the form of a key structure that fits into a hole 310 in the beam, and also engages with a feature on the module frame. Additional details regarding exemplary key structures are provided below.

FIG. 3C is simplified enlarged end view of the module racking embodiment of FIG. 3. Here, particular beam dimensions are labeled, but embodiments are not limited to these or indeed to any particular dimensions.

FIG. 3D shows another simplified enlarged perspective view of the module racking embodiment of FIG. 3. Here, the key structure of the joint transfers bending from module to adjacent module via heel-toe action which is useful in resisting wind uplift

Details regarding the module mounting configuration according to this exemplary embodiment, are now described. Specifically, it is noted that due to the presence of the gaps engineered between modules, the module frame may be called upon to transmit load in only one direction (orthogonal to the beam).

Accordingly, embodiments comprise a long, continuous beam that may be fabricated directly from sheet metal with minimal processing. That beam mates with the frame of the module utilizing the joint in the form of the key structure.

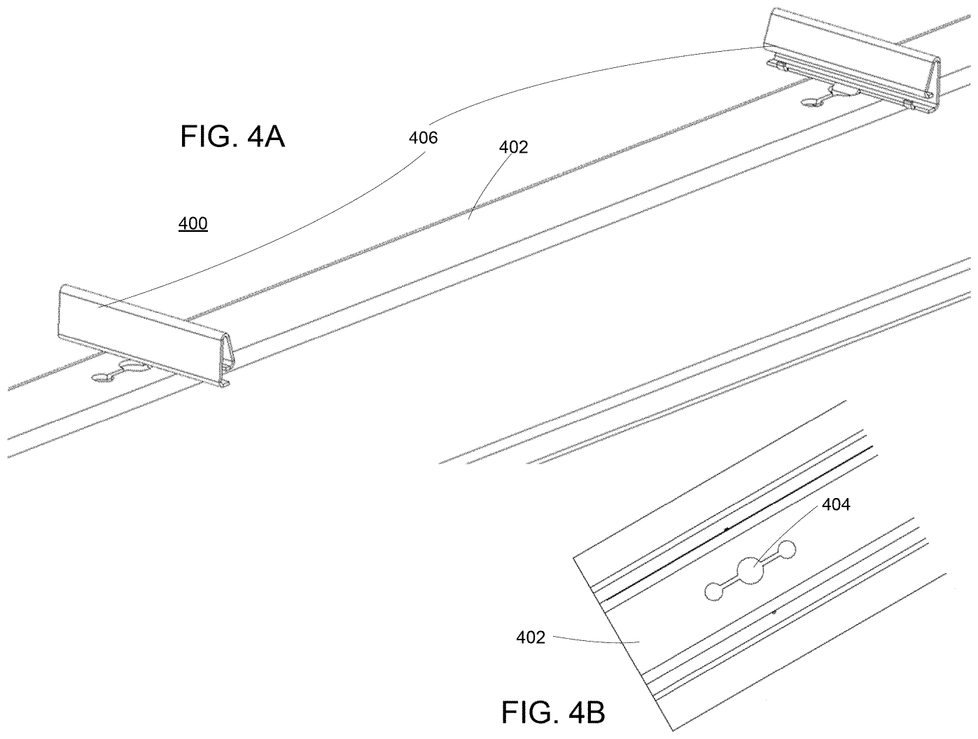

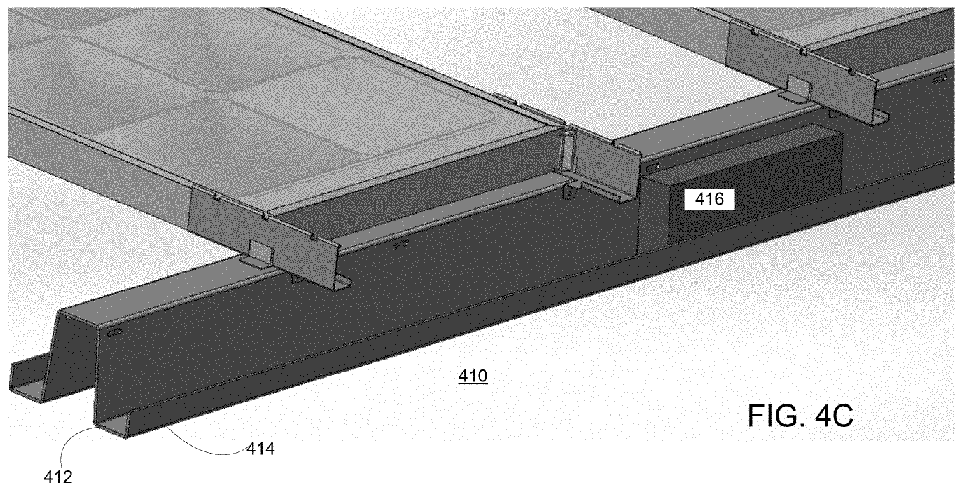

FIG. 4A shows a simplified perspective view of a portion of a racking embodiment 400, with the module removed for purposes of illustration. This view shows two joints 406, here shaped as key structures.

FIG. 4B is simplified top view of an embodiment of the beam 402. In this embodiment, the beam comprises continuous steel sheet metal with minimal manufacturing (e.g., slots 404).

FIG. 4C shows a perspective view of a beam 410 according to an alternative embodiment. Here, flanges 412 of the beam have tabs 414 to capture and retain a ballast block 416.

As described extensively below, the key structure comprises a hat section that sits directly on a roof portion of the beam. A complex slot structure allows the key to be installed and captured by the beam in its installed orientation.

The racking system as described herein allows for solar modules to be spaced arbitrarily while retaining structural continuity due to:
continuous beams extending in one direction; and
moment-carrying module frames in the perpendicular direction.

Details regarding use of a joint in the form of a key structure for module attachment, are now provided. In particular, a racking system according to embodiments may call for a strong structural connection in order to allow adjacent modules to transfer load. However, strong structural connections may utilize bolts or other mechanical fasteners that are expensive, heavy, and relatively time-consuming to install.

Accordingly, embodiments may feature a metal key structure that can fit in a slot in the sheet metal beam, and then be retained therein upon rotation by 90°. This key structure also has a tab to allow the module to snap in from above.

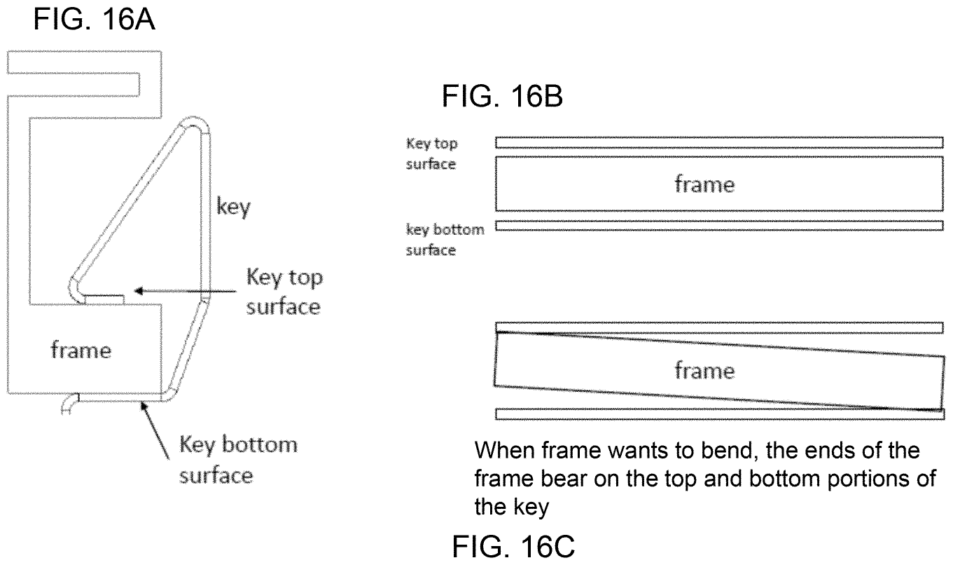

The length of the key structure allows the solar module frame to transmit bending forces from one module to another via ‘heel-toe’ action. FIGS. 16A-C are end views of the key structure showing the heel-to-toe forces.

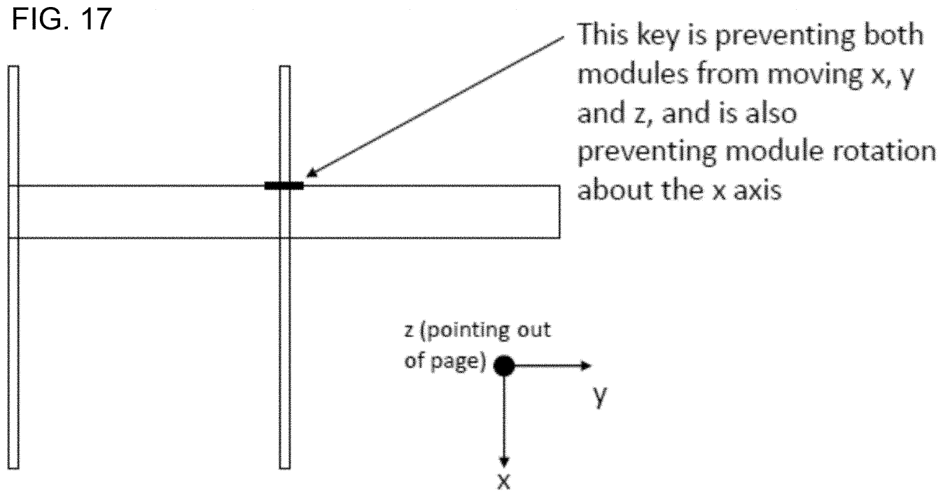

The key structure thus serves to establish three connections in one device. FIG. 17 is a top view further showing the role of the key structure.

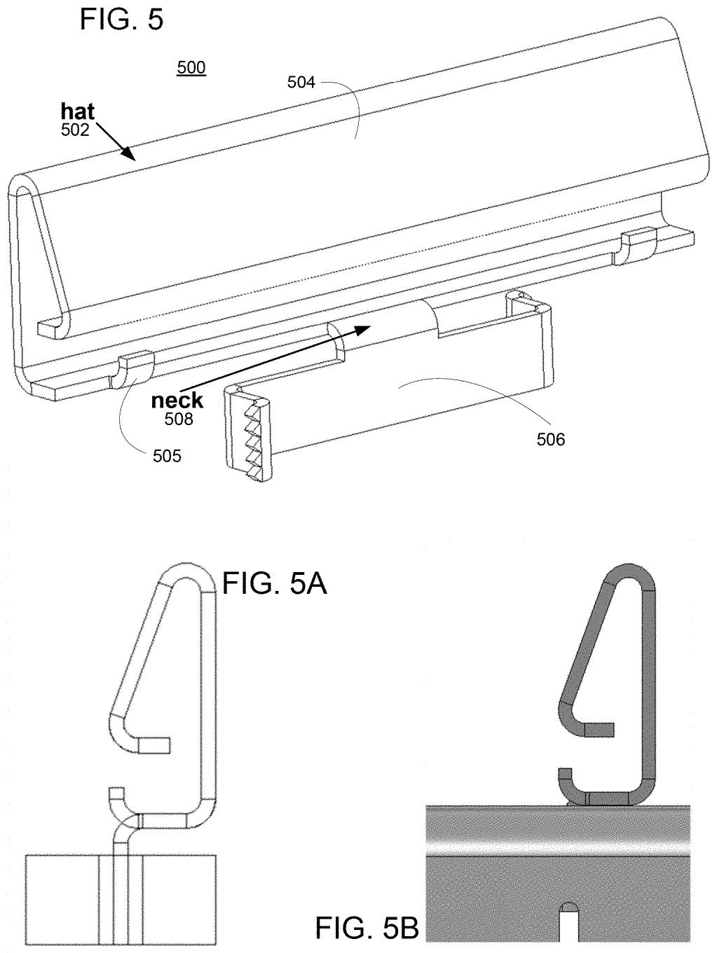

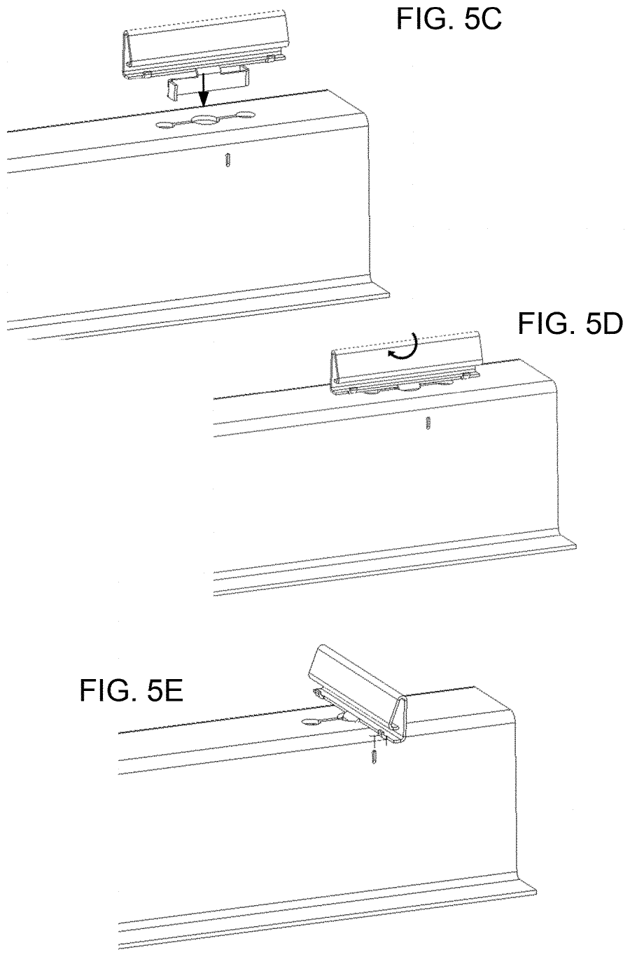

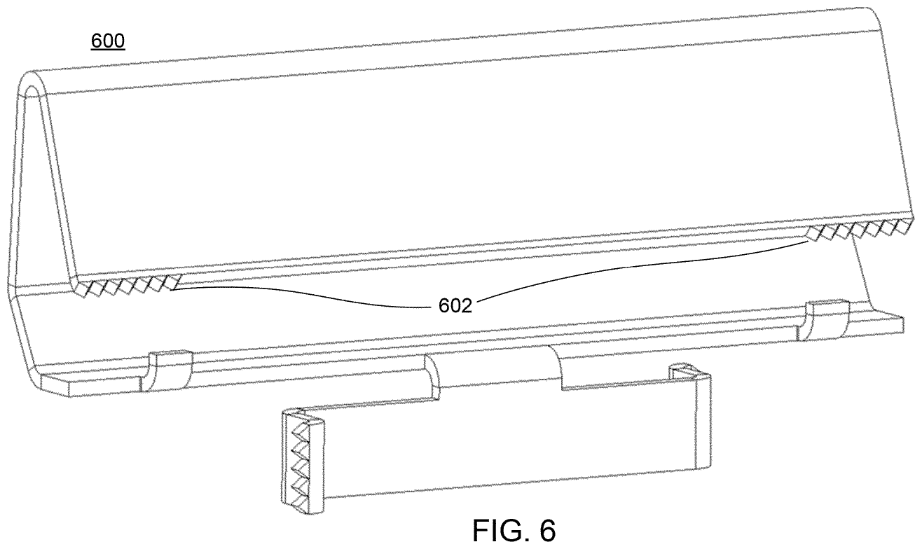

FIG. 5 shows a simplified perspective view of a joint in the form of a key structure 500 according to an embodiment of a racking system. The key structure comprises an upper, hat portion 502 including a flexible top flange 504. The top flange flexible enough to be pushed in by a solar module (e.g., solar module frame) when installed, and then snaps back in place to retain the module in place. Indexing features 505 capture the module in lateral movement

The key structure further includes a bottom flange 506. That bottom flange is designed to retain the key structure within the beam once inserted. A neck portion 508 allows the key structure to rotate once inside the hole within the beam.

FIG. 5A shows a simplified side view of the embodiment of the joint shown in FIG. 5. FIG. 5B shows a simplified side view of the embodiment of the joint shown in FIG. 5, positioned disposed within a beam member.

FIGS. 5C-5E show simplified perspective views illustrating the installation of the joint in the form of the key structure FIG. 5, into a beam. The key structure is captured by the beam after the hat section is rotated about 90°.

The key structure described above represents only one particular embodiment, and different variations are possible. For example, certain embodiments may include burr(s) for grounding. Such burrs could be located:
on the keyed part (into side of rail);
on the bottom face of keyed part to rail; and/or
on the bottom face of capture flange to module.

FIG. 6 is simplified perspective view of another embodiment 600 of a joint in the form of a key structure. This embodiment features a burr 602 with sharp edges to establish a grounding connection.

And while the lower part of the particular key structure of FIG. 5 includes tabs to bear for positive engagement, alternative embodiments may feature tabs that project through slots in the side of the rail.

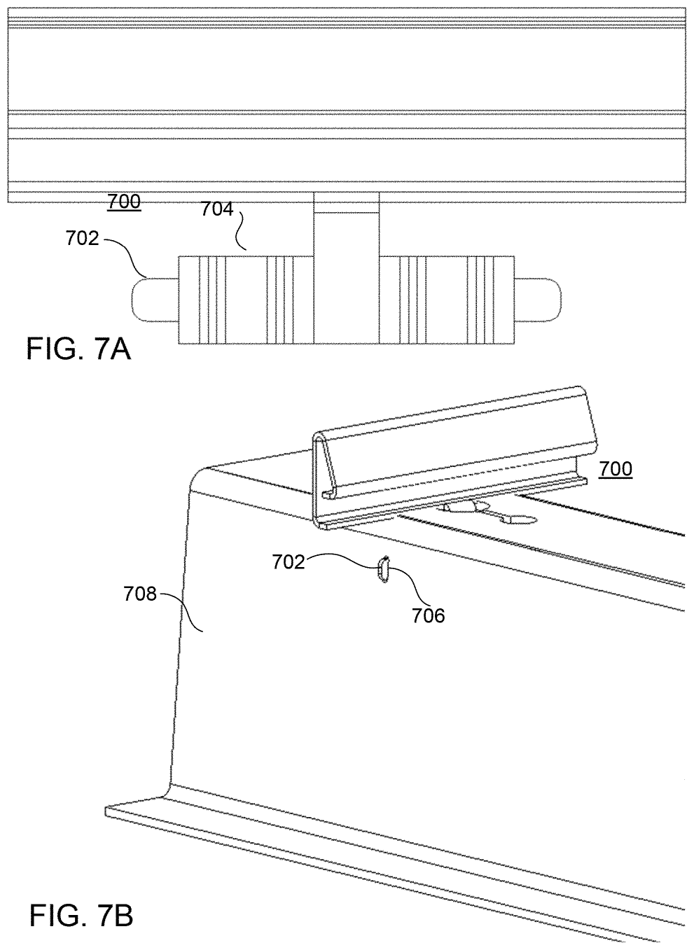

Accordingly, FIGS. 7A-7B show simplified front and perspective views, respectively, of still another embodiment 700 of a joint. In this embodiment, tabs 702 on the bottom flanges 704 pop through holes 706 in the beam 708 once the key is turned to its final orientation. The tabs do not allow the key structure to rotate past 90° once installed. The tabs could be tapered for positive engagement to cinch the key structure down onto the beam.

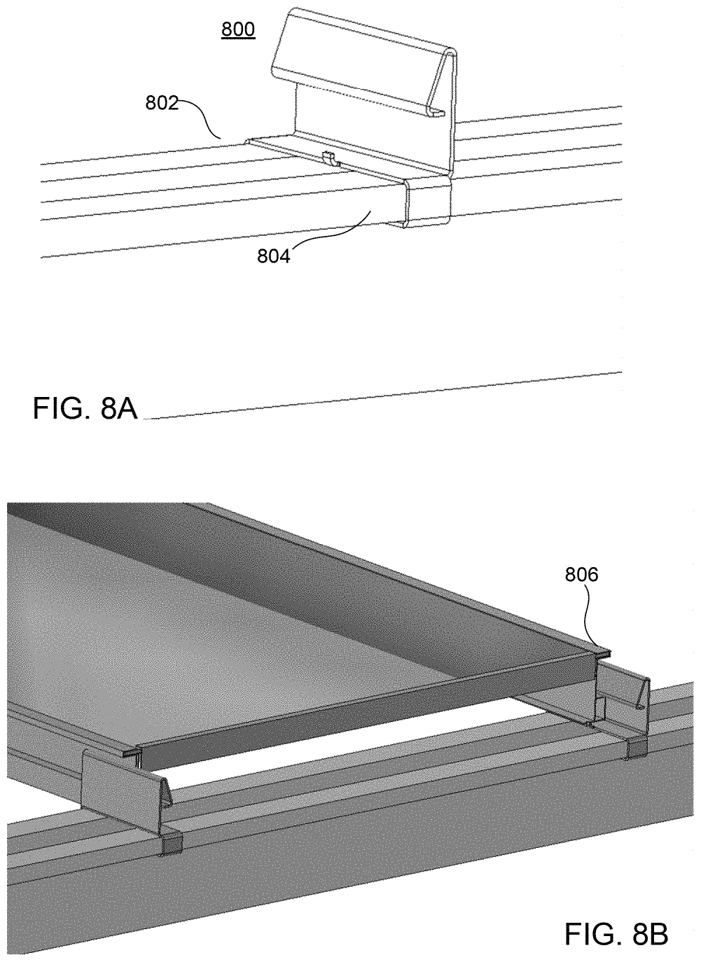

According to some embodiments, the key structure can be a car that slides on top of a beam while captured, instead of twisting into place. FIG. 8A shows a simplified perspective view of another embodiment 800 of a joint disposed on a beam 802. The drawing shows the key structure being captured via sliding on top of the beam while wrapping around its flanges 804. FIG. 8B shows a simplified perspective view of the installation of a module 806 into the joint embodiment of FIG. 8A.

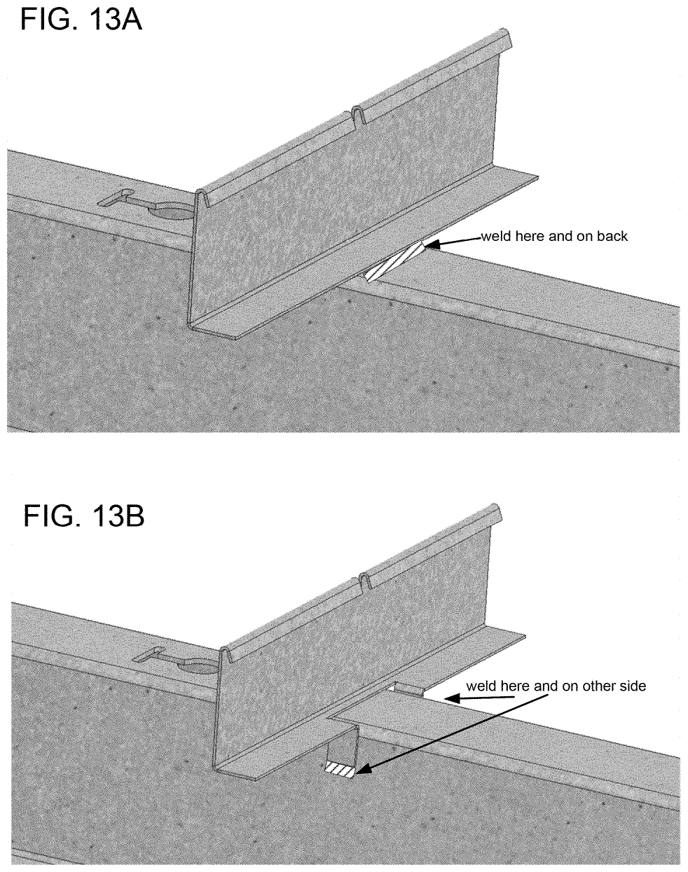

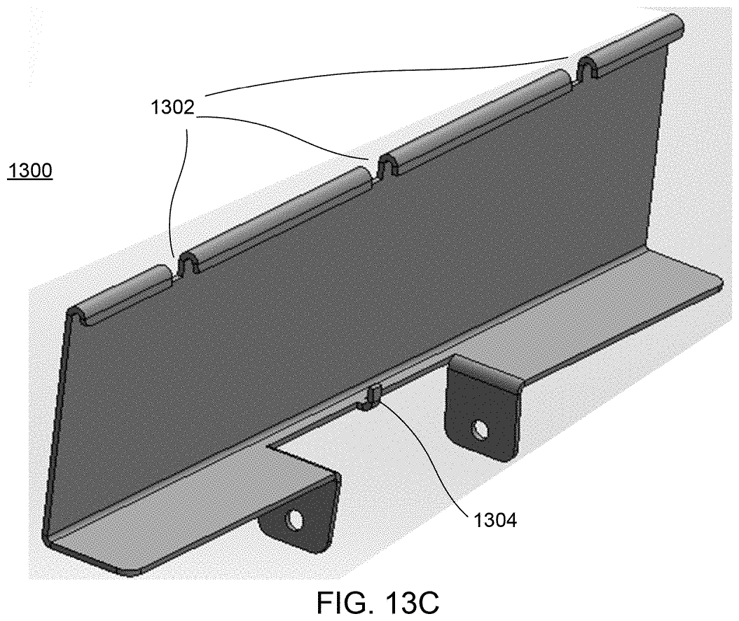

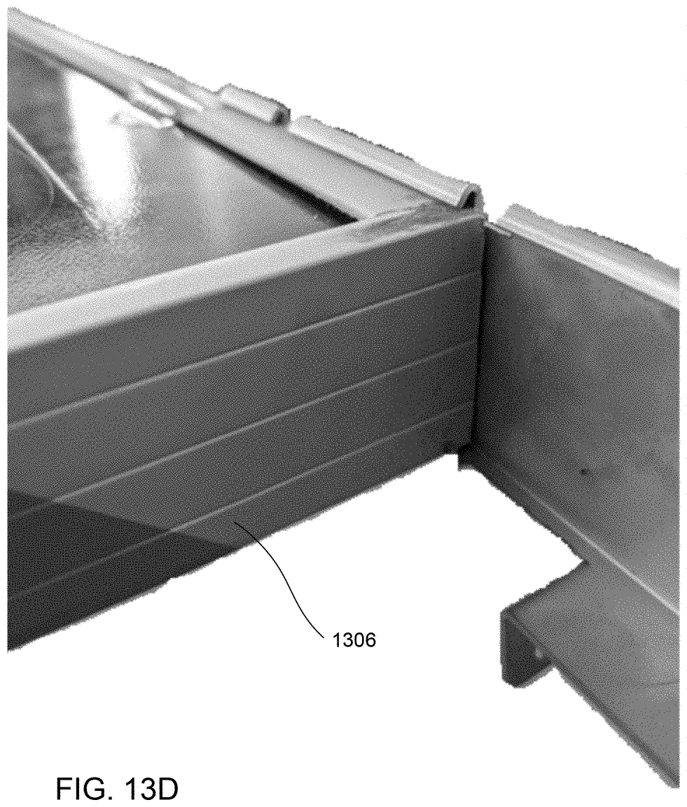

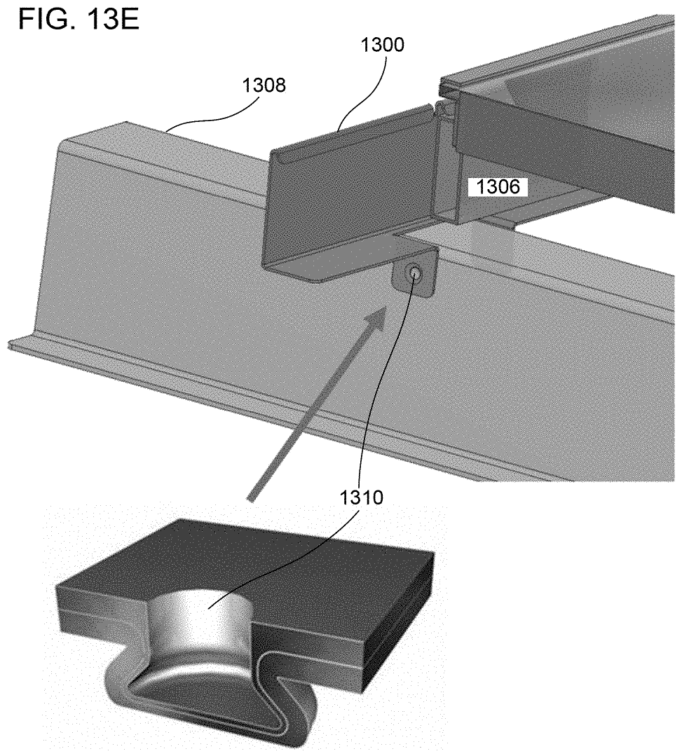

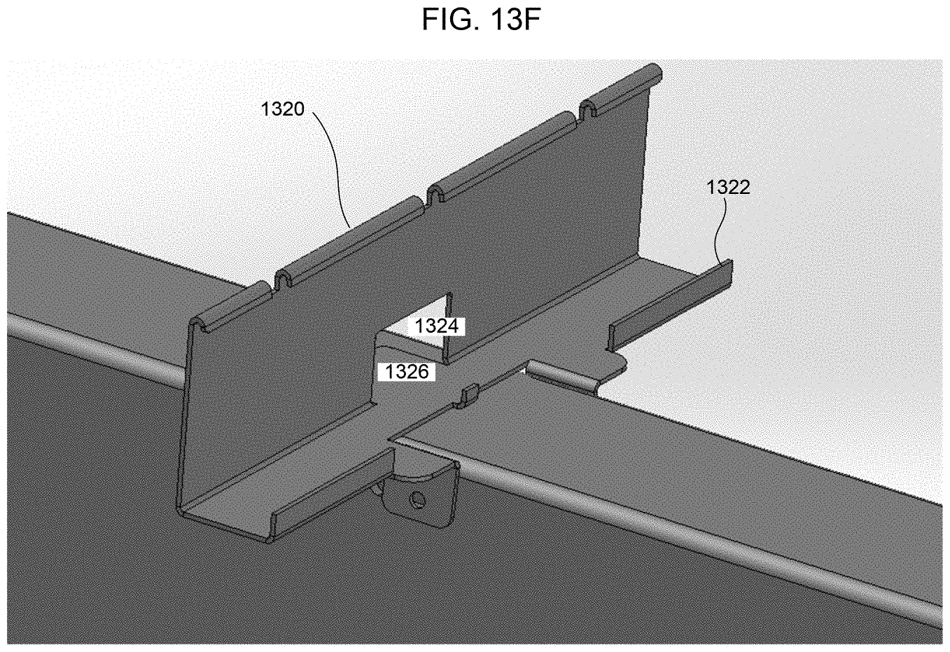

It is noted that in some embodiments, additional steps may ensure the secure contact between the joint and the beam. FIGS. 13A shows a perspective view of a key structure fitted by rotation, as being secured by welding to a beam. FIGS. 13B shows a perspective view of a key structure fitted by sliding, as being secured by welding to a beam.

According to some embodiments, a joint (e.g., key structure) can be pre-attached to the beam via a bolt, welding, and/or punching in a factory ahead of time. This could potentially save money, as labor is more expensive on a roof than in a factory.

Moreover, this is a benefit of having the continuous beam be a single piece that holds many modules. Commonly in the industry, each module mount is assembled and installed on the roof. Having a single piece with the attachments pre-installed for many modules could offer an advantage in terms of time and cost.

FIG. 13C is a simplified perspective view of an alternative embodiment of a joint 1300. FIG. 13C shows cutaways 1302 at the top for access to uninstall, and a tab 1304 at the bottom for indexing between modules. Simplified design allows for attachment to a standard module frame.

FIG. 13D shows a simplified perspective view of the joint embodiment of FIG. 13C, attaching to a module frame 1306.

FIG. 13E shows a detail illustrating attachment of a metal beam using the joint embodiment of FIG. 13C. In FIG. 13E, the joint 1300 is attached to the metal beam 1308 by clinching, to form a clinch joint 1310.

FIG. 13F shows a perspective view illustrating yet another embodiment of a joint 1320. This embodiment includes tabs 1322 to align the module from the bottom of the frame on the bottom of the clip as well as clipping the module from the top. This embodiment further includes a cut out 1324 to create a center tab 1326 to increase stability of the joint on the beam during installation.

A joint can be made out of metals, including but not limited to steel or aluminum. Fabrication of the joint from sheet metal could facilitate machining, with the potential for extruding, forging, and/or casting.

Certain joint embodiments could accommodate insertion of the module (e.g., module frame) from the side. Joint embodiments can be of any length that snaps into the module.

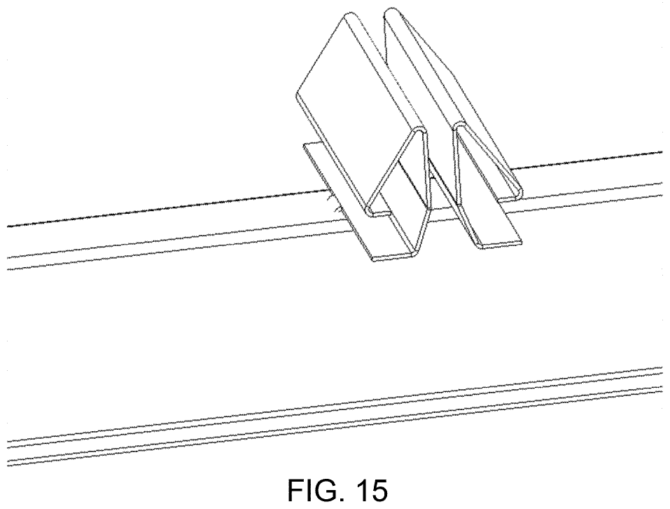

Certain configurations could involve the placement of two joints back-to-back, to achieve high module density. FIG. 15 shows a perspective view illustrating two (2) key structures positioned in a back-to-back orientation. Some embodiments could be bent out in order to better accommodate the module features (e.g., frame).

Moreover, while certain figures show embodiments where the key structures are located adjacent to (and possibly bent out from) the side of the module, this is not required. Alternatively a joint (e.g., key structure) can be located underneath the module.

Such a configuration could conserve area in the plane of the racking system, so that joints do not consume available surface. In some embodiments, a lower flange located at the bottom of the module frame, goes underneath the module. One such embodiment is described later below in connection with FIG. 9E.

Various aspects of solar module designs according to embodiments, are now discussed. The frame feature of a module is described first.

Specifically, in order to not move in response to applied forces (e.g., to not lift up in the wind), the racking system may need to be meaningfully structurally connected. However, including an extra beam other part underneath the solar module, may add expense in material and installation.

To avoid this, racking system embodiments may utilize a solar module frame that in one direction is sturdy enough to transfer the load of the entire mounting system (not just the module itself). This can eliminate the need for additional, expensive racking components.

FIG. 9A shows a simplified perspective view of one embodiment of a module frame 900, with a module 902 in place therein. FIG. 9B shows a simplified end view of the module frame of FIG. 9A.

In this embodiment, the frame is present along a long side L of the module. A top lip 903 captures the front glass of the module.

The long side frame (which may have a same depth as a traditional module) has a bottom flange 904 to be captured by the snap-in feature of the key structure.

FIG. 9C illustrates an enlarged perspective view of a module frame and module according to an embodiment. The long side frame has an opening 906 receiving a corner piece 908 to be installed to connect with the short side module frame 910.

In this embodiment, the long side frame offers a specific shape that allows for the module to snap into the indexing feature present on the key structure. The shape of the long side module frame is similar to a ‘C’, which is efficient in bending.

FIG. 9D illustrates a simplified perspective view of an alternative embodiment of the short side frame of the module. This short side frame is half as deep as the long frame. It has a corresponding opening 912 to receive the corner piece to connect with long frame.

In this embodiment, the short frame does not need to capture the glass of the module from above. The short side frame comprises a smaller amount of material because the module supports little or no load in this direction. It may have a specific shape optimized for low cost manufacturing.

FIGS. 9E and 9F illustrate end views of module frame embodiments. In FIG. 9E, the standard frame shape could be present along the long side, along the short side, or along both sides.

In the embodiment of FIG. 9E, the key structure could be underneath the module. This may be desirable as previously described.

Under some circumstances, no frame at all may be present along the short side of the module. The module could be glass-glass, or glass-backsheet with a sheet metal beam glued to the back.

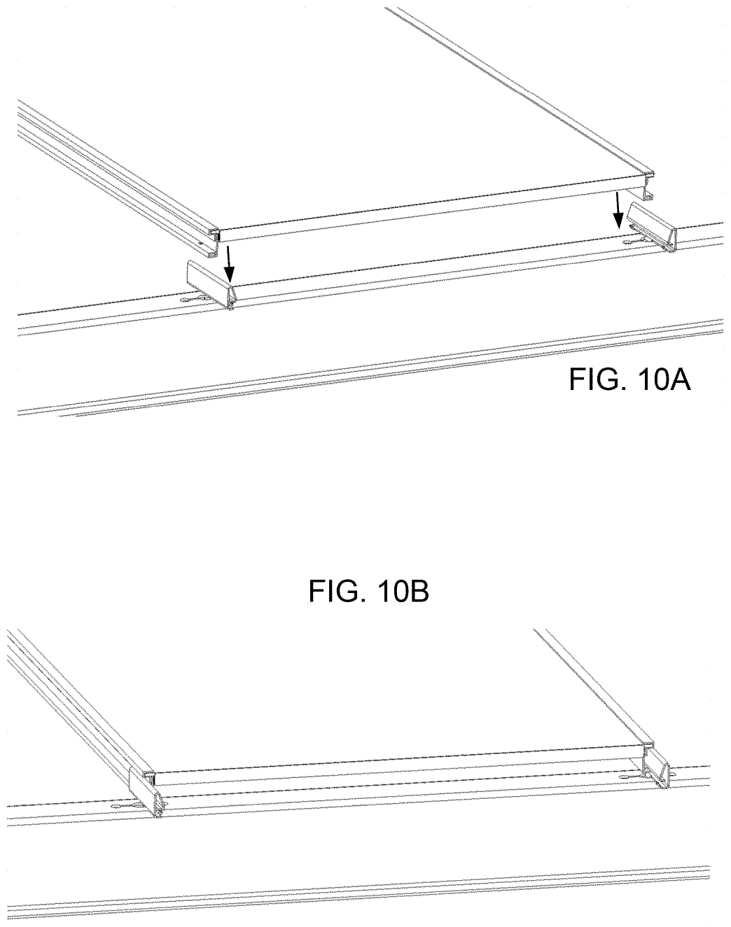

FIGS. 10A-B are simplified perspective views illustrating installation of a module frame into a joint according to an embodiment. Once the module is snapped in, the key is unable to rotate and thereby fully locked into position. Examples of ranges for installation forces for a module into a racking system according to embodiments, can vary from between about 25-500 lbs.

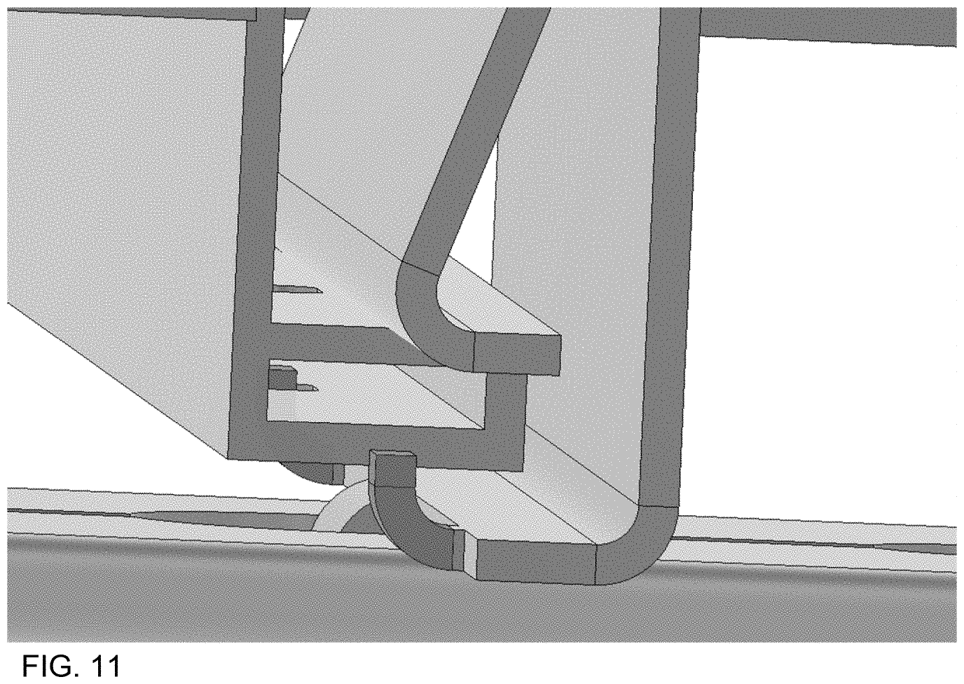

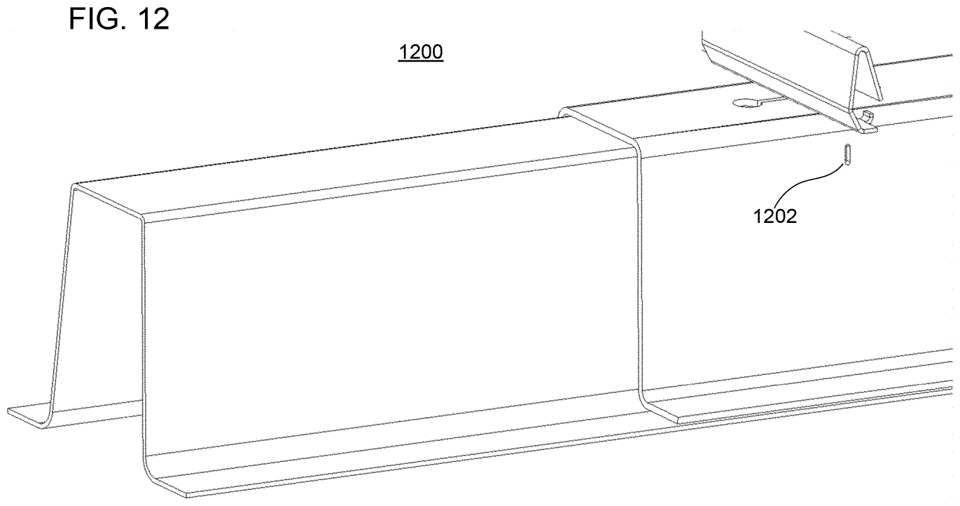

FIG. 11 is a simplified perspective view illustrating mating between a joint and an installed module frame, according to one embodiment of a racking system. The hole in the module frame may capture the module in its long direction and ease installation

Under some circumstances, beams may stand alone and not be connected to an adjacent beam on a project. However, under other circumstances, it may be beneficial to add a small number of modules to an existing racking system. This can be accomplished using a beam-to-beam connection.

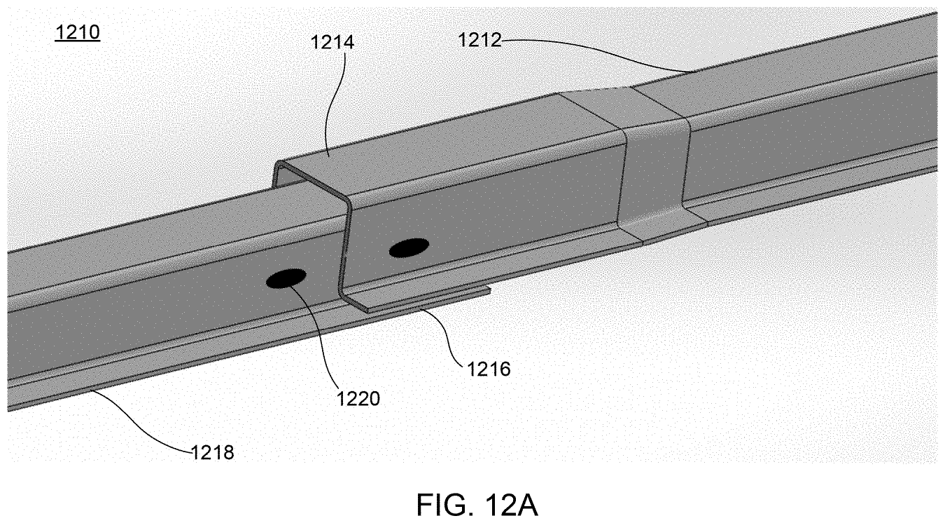

FIG. 12 shows a simplified perspective view of a beam-to-beam connection 1200 according to an embodiment. As shown at 1202 the lower portion of the key structure can fit into a hole present in both beams, in order to retain the connection. The beams could transmit an upward bending force through heel-toe action against the beam roof

At 1204, FIG. 12 shows one beam flared out to a slightly larger size at both ends. At 1206, FIG. 12 shows a first beam that is not flared out and fits inside the flare of the first beam.

FIG. 12A shows a simplified perspective view of a beam-to-beam connection 1210 according to an alternative embodiment. Here, beam 1212 is shown with a flared end 1214 such that the opposite end 1216 of another beam 1218 can slide inside. Both of the beams have dimpled features 1220 that are stamped into the metal so that when the beam is slid in to a certain depth, it is engaged.

Clause 1A. An apparatus comprising:
a first beam extending in a first direction;
a first solar module having a width dimension in the first direction and a length dimension in
a second direction, the length dimension larger than the width dimension;
a first joint securing the first solar module to the first beam;
a second beam;
a second solar module; and
a second joint securing the second solar module to the first beam at a gap from the first solar module.

Clause 2A. An apparatus as in clause 1A wherein:
the first beam is parallel to the second beam;
the second solar module has the width dimension in the first direction and the length dimension in the second direction.

Clause 3A. An apparatus as in clause 1A wherein the first solar module has a frame extending in the length dimension.

Clause 4A. An apparatus as in clause 3A wherein the first joint is connected to the frame.

Clause 5A. An apparatus as in clause 4A wherein the frame also extends in the width dimension.

Clause 6A. An apparatus as in clause 5A wherein a strength of the frame in the length dimension is greater than a strength of the frame in the width dimension.

Clause 7A. An apparatus as in clause 1A wherein a distance of the gap corresponds to the width.

Clause 8A. An apparatus as in clause 1A wherein a distance of the gap is other than the width.

Clause 9A. An apparatus as in clause 1A wherein the joint comprises a key structure that is inserted into the beam.

Clause 10A. A method comprising:
disposing a first beam extending in a first direction on a surface;
securing a first solar module to the beam with a first joint, the first solar module having a width dimension in the first direction and a length dimension in a second direction, the length dimension larger than the width dimension;
securing a second solar module to the beam with a second joint, the second solar module separated from the first solar module by a gap, wherein the gap offers an area of between about 5-75% of a combined area offered by the first module and the second module.

Clause 11A. A method as in clause 10A wherein the first direction is approximately orthogonal to the second direction.

Clause 12A. A method as in clause 10A wherein a distance of the gap corresponds to the width.

Clause 13A. A method as in clause 10A wherein the surface comprises a tilt-up roof

Clause 14A. A method as in clause 10A wherein securing the first solar module to the beam comprises:
disposing a portion of the first joint into the beam; and
inserting another portion of the first joint into a frame extending along the length.

Clause 15A. A method as in clause 14A wherein the inserting comprises applying a force out of a plane defined by the first direction and the second direction.

Clause 16A. A method as in clause 14A wherein the inserting comprises sliding.

Clause 17A. A method comprising:
providing gaps between solar modules in a racking system to increase an overall surface area of the racking system and thereby reduce a ballast force per-unit-surface-area of the racking system.

Clause 18A. A method as in clause 17A wherein the ballast force per-unit-surface area is supplied entirely by a weight of the racking system including the solar modules.

Clause 19A. A method as in clause 17A wherein the racking system is disposed on a tilt-up roof

Clause 20A. A method as in clause 14A wherein the first joint is secured to the beam by clinching.

Returning now to FIG. 1, that figure shows a solar module racking approach lacking separate cross-members. Thus, only the module frames provide structure along the Y direction.

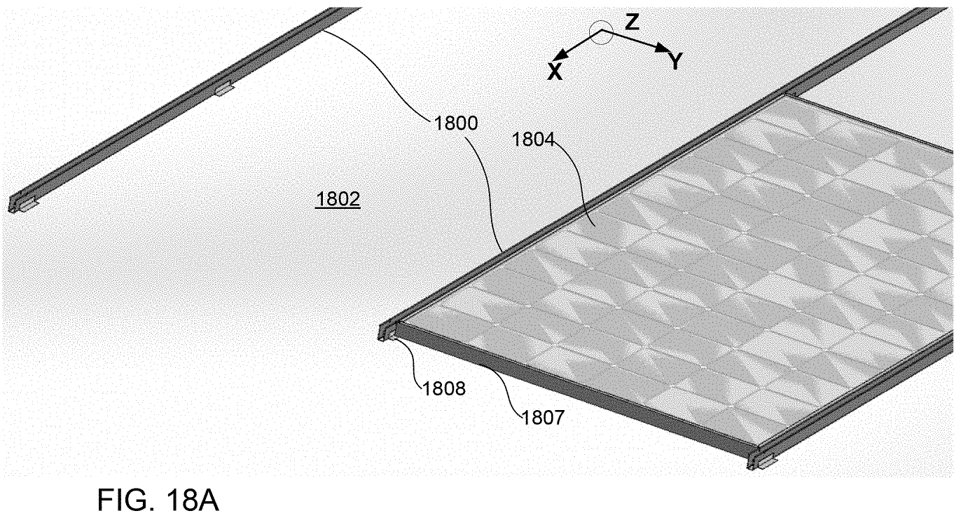

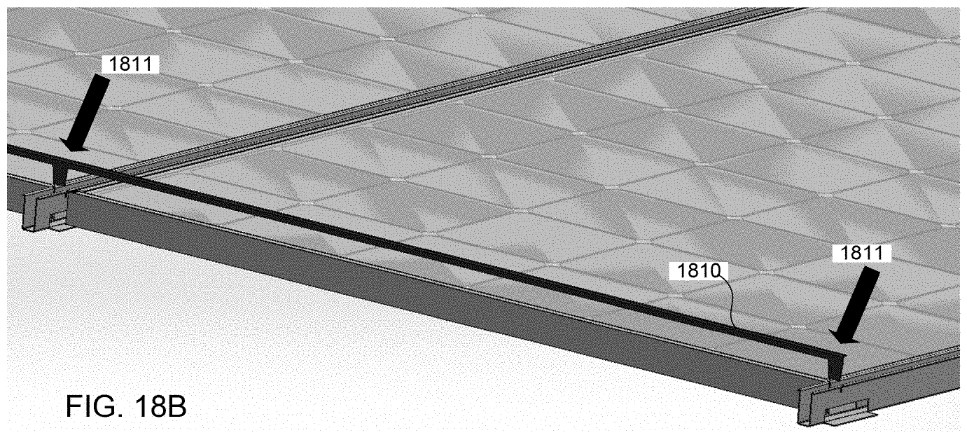

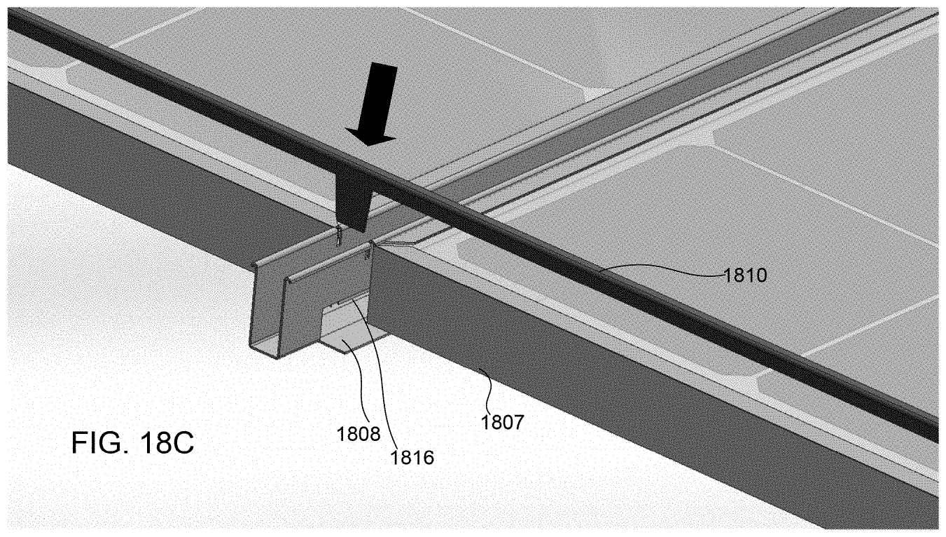

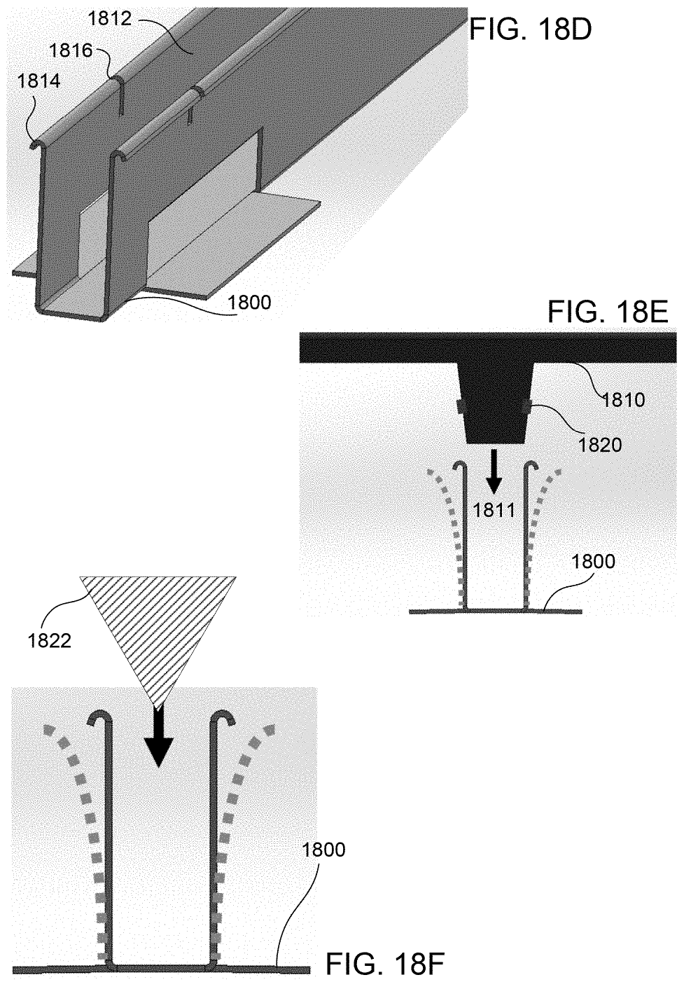

However, this is not required, and alternative embodiments could include separate and distinct cross-members to provide support along a direction orthogonal to the main axis of the beams. FIGS. 18A-F show various views of such an alternative embodiment.

In particular, FIG. 18A shows a perspective view of a solar module racking approach according to an alternative embodiment, during installation. Here, beams 1800 are first placed on the roof 1802. Then, PV modules 1804 are subsequently added with their frames 1807 sitting on the tabs 1808 on the beams.

Once multiple modules have been placed down in this manner, a cross-member 1810 is pressed 1811 down onto multiple beams, as shown in the detail view of FIG. 18B.

FIG. 18C shows a detail view of the solar module rack of FIG. 18C during installation. This beam has a cutout 1816 to create the tabs 1808 for the bottom of the module to sit on, in order to keep the module off of the roof directly.

FIG. 18D shows a perspective view of a beam according to the embodiment of FIG. 18A. Beam 1800 has two flanges 1812 with lips 1814 to grab the module frame.

Also shown are cutouts 1816 for the cross-member to wedge in and engage. This cross member can be as short as 1 module length (e.g., 6 feet) or up to 20 feet or more.

FIG. 18E is an end view of a beam showing installation of a cross-member. This cross-section shows how the cross-member 1810 is lowered and pressed 1811 into the beam 1800, causing the two flanges to pry outwards and engage on the module frame, rigidly holding it into place (dotted). Once the cross-member is wedged in, tabs 1820 engage with cutouts on the first beam, locking the structure in place. The resulting racking arrangement could be as small as four modules, or as large as fifty or even more.

It is noted that a cross-member is not required to be installed at every intermediate module. Where a cross-member is not present, as shown in FIG. 18F a wedge 1822 member could be used to engage the beam to clamp onto the module frame.

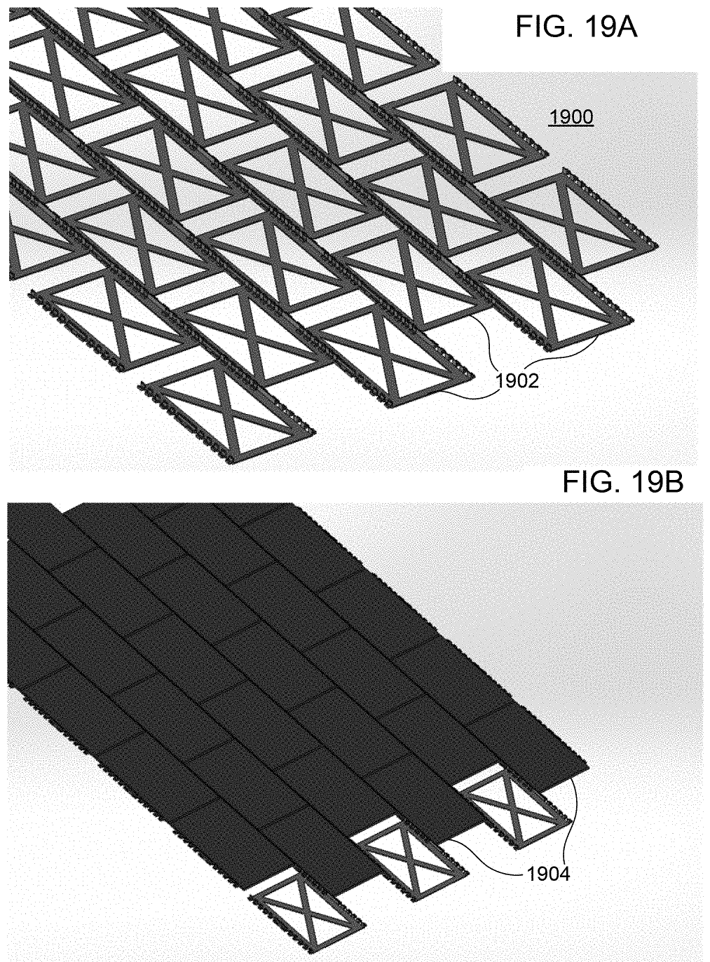

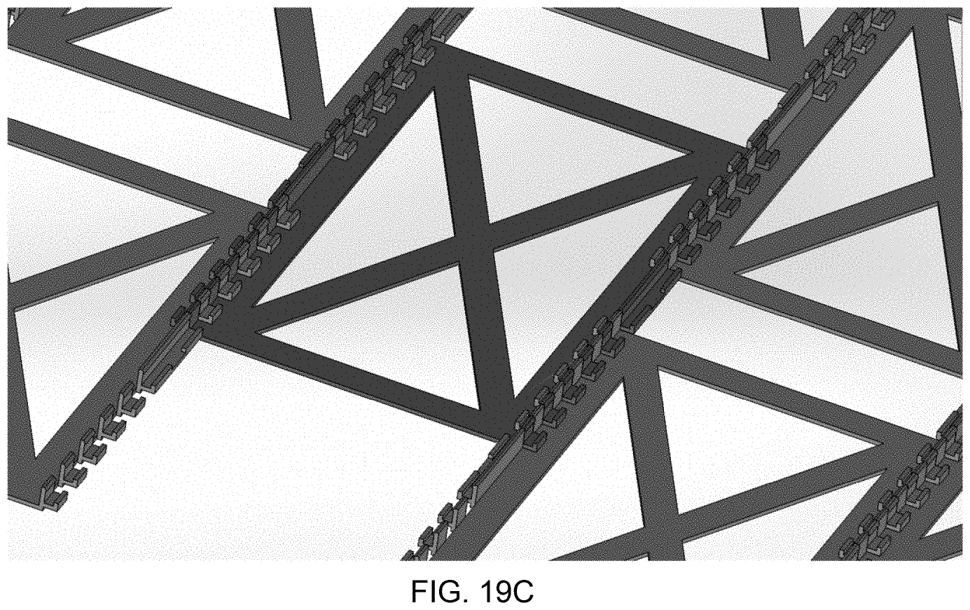

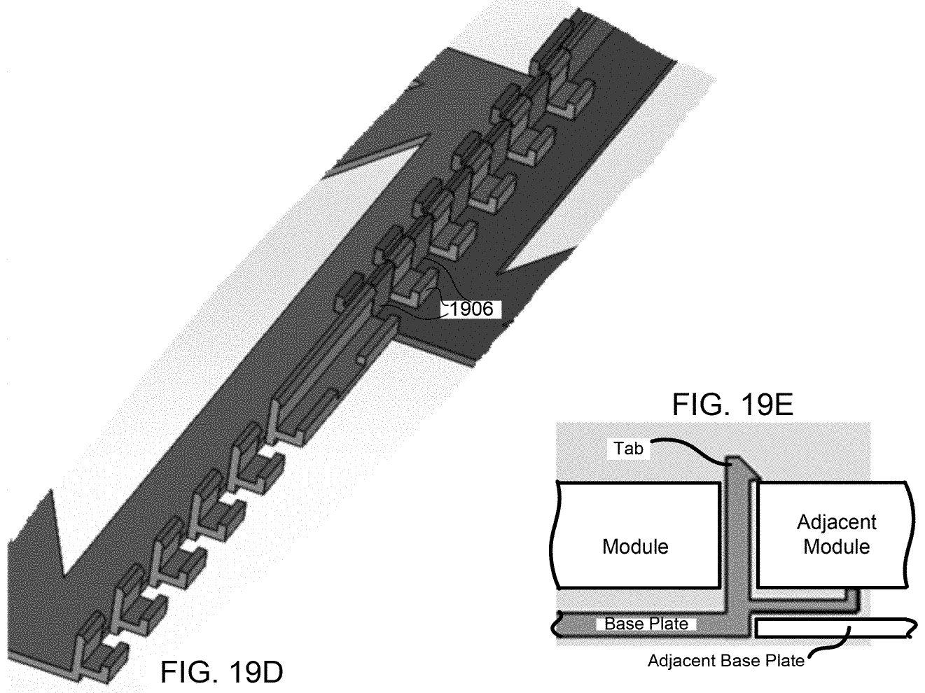

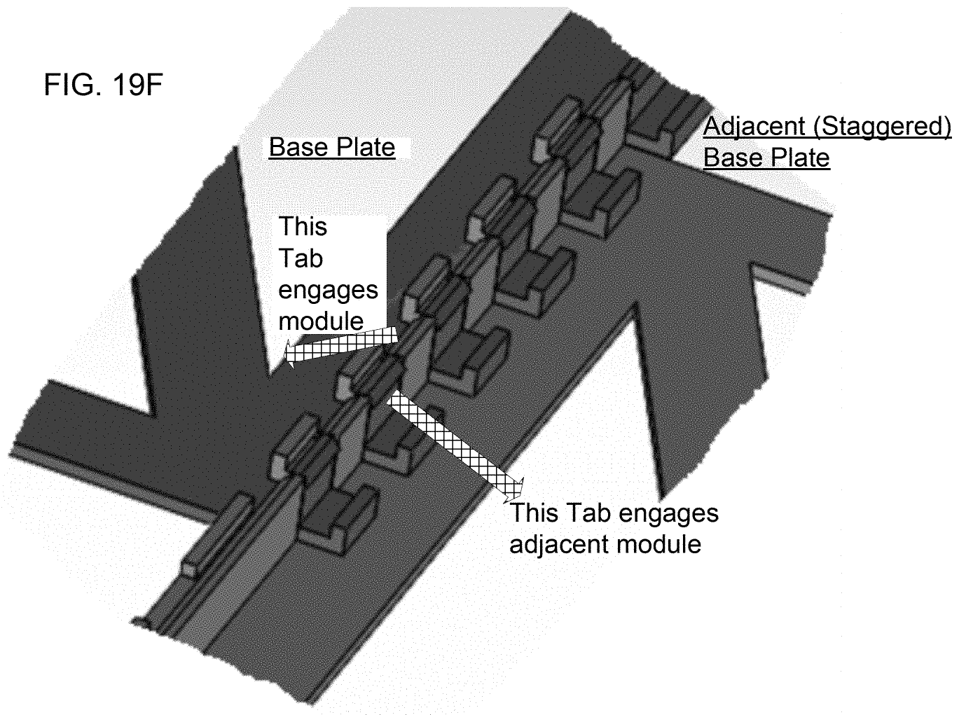

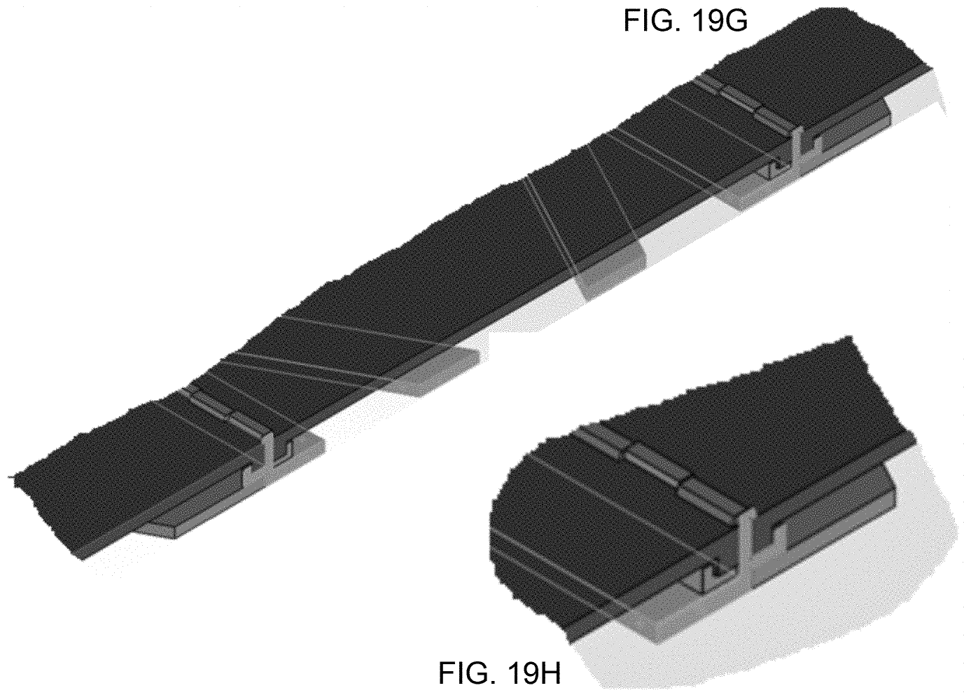

Alternative embodiments for supporting solar modules are possible. FIG. 19A is a simplified perspective view showing an array 1900 of staggered base plates 1902 according to an exemplary embodiment.

FIG. 19B shows the array of staggered base plates of FIG. 19A, further having solar modules 1904 affixed thereto. It is noted that the modules are larger (longer) than the underlying base plates.

Here, the arrangement for a roof mounted system features base plates that are staggered. This stagger provides overlapping continuity of module frames to provide stiffness.

As shown, each module has a base-plate structure present underneath it. FIG. 19C shows an enlarged perspective view of the array of staggered base plates of FIG. 19A.

The base plates are installed first, and then modules are snapped in from above. This completes the composite mount structure.

FIG. 19D shows an enlarged perspective view of one side showing the inter-digitated tabs 1906 of the base plates. FIG. 19E is a detail cross-sectional view showing the tab structure on the base-plate.

As shown, these tabs are raised up and overlap with the adjacent base plate. The tabs engage with the adjacent module frame.

This arrangement provides a robust connection throughout the entire array. The resulting stiffness and rigidity imparted to the module by virtue of its being a connected structure, helps to reduce the need for ballast. Also, the fact that the module locks into the structure is useful for installation purposes.

For purposes of illustration, FIG. 19F shows a further enlarged perspective view of one side of inter-digitated base plates. FIG. 19G shows a cross-section of a base plate supporting a module, together with adjacent base plates and modules. FIG. 19H shows an enlarged view of the cross-section of FIG. 19G.

The base plates can be made out of sheet metal (e.g., steel and/or aluminum). Pregalvinized coil, hot dipped galvanized steel, or stainless steel may be employed to impart corrosion resistance.

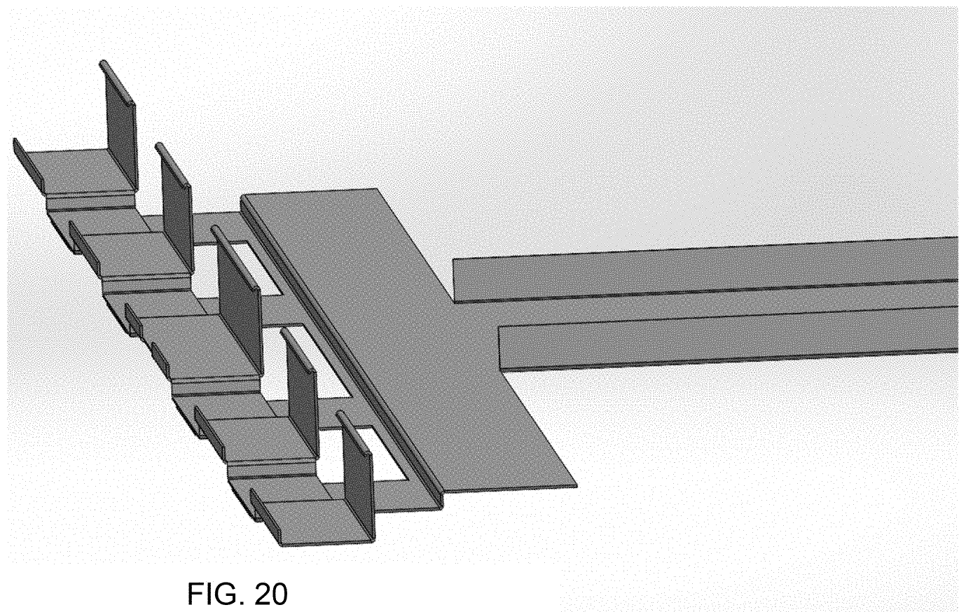

The base plate could be stamped from a single piece of metal. FIG. 20 shows a partial perspective view of an embodiment of a base plate having one transverse member (rather than the cross-member of the above embodiments) and fabricated as a single piece.

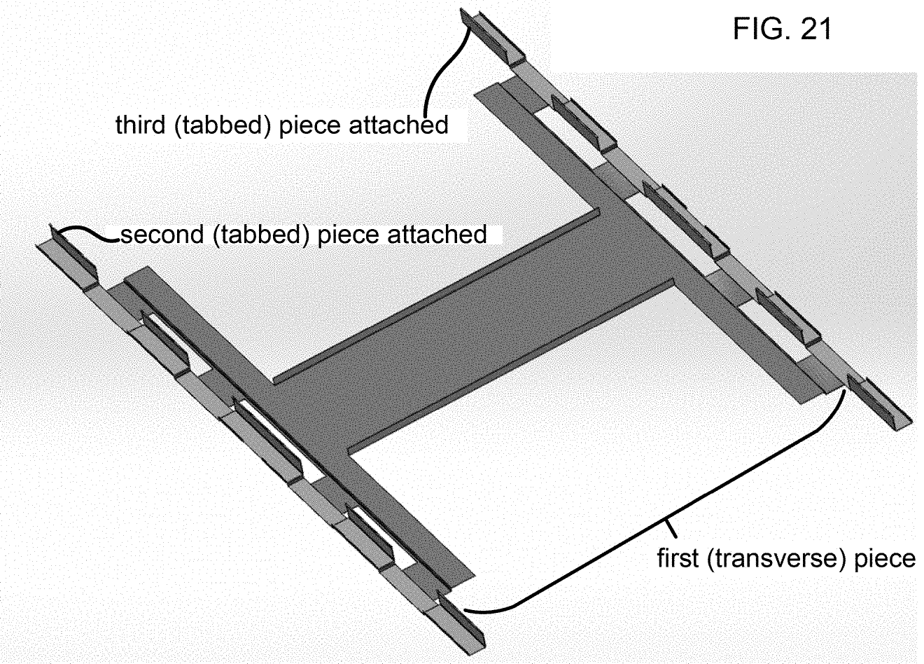

Alternatively, the base plate could be built up (with rivets, bolts, screws, or clinching) from two or more sub-pieces of metal to better utilize the parent material coil. FIG. 21 shows a partial perspective view of another embodiment of a base plate having a single transverse member and comprising a separate attached piece for each tabbed edge.

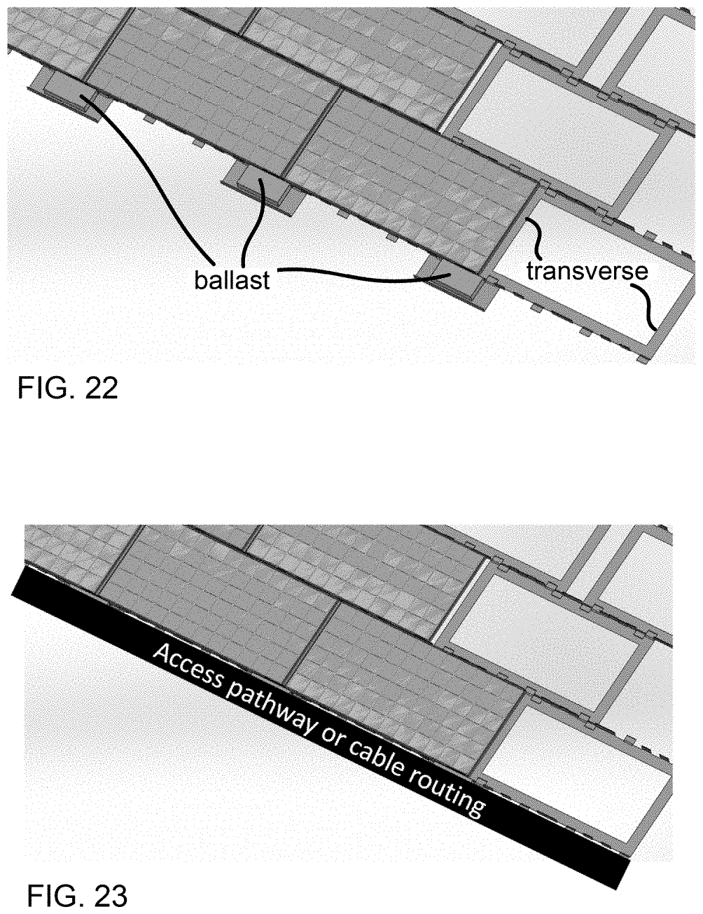

Due to the nature of the interlocking tabs, modules at the edge of the array may need to be held down in order to resist external (e.g., wind) forces. This can be achieved by dedicated mini-base-plates which can house ballast bricks. FIG. 22 shows a perspective view of an array of base plates according to an embodiment held down by ballast bricks.

Alternatively or in combination with the use of ballast, edge modules may be held down by structures containing wiring routed back to the inverter, or a providing a dedicated access walkway. FIG. 23 shows a perspective view of an array of base plates and modules according to an alternative embodiment including a pathway for access and/or cable routing.

In connection with the embodiments of FIGS. 22-23, it is noted that the base plate comprises a rectangle with transverse elements located at either end. This be compared with the other base plate embodiments of FIGS. 20-21 (having a single transverse element) and FIGS. 19A-G (which further include additional cross-transverse elements).

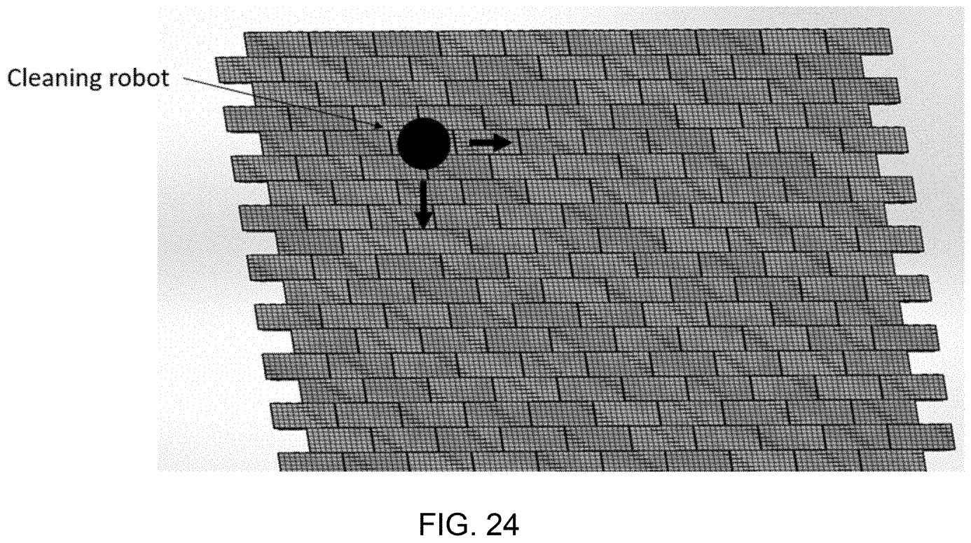

FIG. 24 shows a perspective view of an embodiment of a module array including a cleaning robot. In particular, this connected arrangement of modules may be cleaned with a small cleaning robot that is able to move freely in any planar direction across the modules.

Clause 1B. An apparatus comprising:
a base plate supporting a solar module and having an edge tab engaged with an adjacent solar module supported by an adjacent base plate, wherein,
an edge tab of the adjacent base plate is engaged with the solar module.

Clause 2B. An apparatus as in Clause 1B wherein the base plate and the adjacent base plate are staggered.

Clause 3B. An apparatus as in Clause 1B wherein the edge tab of the base plate is interdigitated with the edge tab of the adjacent base plate.

Clause 4B. An apparatus as in Clause 1B wherein the base plate comprises a transverse element.

Clause 5B. An apparatus as in Clause 4B wherein the transverse element is located at one end of the base plate, the apparatus further comprising:
another transverse element located at an opposite end of the base plate to define the base plate as a rectangle.

Clause 6B. An apparatus as in Clause 1B wherein the base plate comprises a single piece.

Clause 7B. An apparatus as in Clause 1B further comprising ballast located on a side opposite to the edge tab.

Clause 8B. A method comprising:
lowering a solar module onto a base plate to engage with an edge tab of an adjacent base plate; and
lowering another solar module onto the adjacent base plate to engage with an edge tab of the base plate.

Clause 9B. A method as in Clause 8B wherein the base plate and the adjacent base plate are staggered.

Clause 10B. A method as in Clause 8B wherein the edge tab of the base plate is interdigitated with the edge tab of the adjacent base plate.

Clause 11B. A method as in Clause 8B wherein the base plate comprises a transverse element.

Clause 12B. A method as in Clause 8B further comprising locating ballast on a side opposite to the edge tab of the base plate.

What is claimed is:

1. An apparatus comprising:
a first beam extending in a first direction;
a first solar module having a width dimension in the first direction and a length dimension in a second direction, the length dimension larger than the width dimension;
a first joint securing the first solar module to the first beam;
a second beam;
a second solar module; and
a second joint securing the second solar module to the first beam at a gap from the first solar module.

2. An apparatus as in claim 1 wherein:
the first beam is parallel to the second beam;
the second solar module has the width dimension in the first direction and the length dimension in the second direction.

3. An apparatus as in claim 1 wherein the first solar module has a frame extending in the length dimension.

4. An apparatus as in claim 3 wherein the first joint is connected to the frame.

5. An apparatus as in claim 4 wherein the frame also extends in the width dimension.

6. An apparatus as in claim 5 wherein a strength of the frame in the length dimension is greater than a strength of the frame in the width dimension.

7. An apparatus as in claim 1 wherein a distance of the gap corresponds to the width.

8. An apparatus as in claim 1 wherein a distance of the gap is other than the width.

9. An apparatus as in claim 1 wherein the joint comprises a key structure that is inserted into the beam.

10. A method comprising:
disposing a first beam extending in a first direction on a surface;
securing a first solar module to the beam with a first joint, the first solar module having a width dimension in the first direction and a length dimension in a second direction, the length dimension larger than the width dimension;
securing a second solar module to the beam with a second joint, the second solar module separated from the first solar module by a gap, wherein the gap offers an area of between about 5-75% of a combined area offered by the first module and the second module.

11. A method as in claim 10 wherein the first direction is approximately orthogonal to the second direction.

12. A method as in claim 10 wherein a distance of the gap corresponds to the width.

13. A method as in claim 10 wherein the surface comprises a tilt-up roof

14. A method as in claim 10 wherein securing the first solar module to the beam comprises:
disposing a portion of the first joint into the beam; and
inserting another portion of the first joint into a frame extending along the length.

15. A method as in claim 14 wherein the inserting comprises applying a force out of a plane defined by the first direction and the second direction.

16. A method as in claim 14 wherein the inserting comprises sliding.

17. A method comprising:
providing gaps between solar modules in a racking system to increase an overall surface area of the racking system and thereby reduce a ballast force per-unit-surface-area of the racking system.

18. A method as in claim 17 wherein the ballast force per-unit-surface area is supplied entirely by a weight of the racking system including the solar modules.

19. A method as in claim 17 wherein the racking system is disposed on a tilt-up roof

20. A method as in claim 14 wherein the first joint is secured to the beam by clinching.
